(19) United States
(12) Patent Application Publication
(10) Pub. No.: US 2026/0267686 A1
(43) Pub. Date: Sep. 10, 2026

(54) VALUE DATA SELECTION

(71) Applicant: Arm Limited, Cambridge (GB)

(72) Inventors: Rune HOLM, Oslo (NO); Dominic Hugo SYMES, Cambridge (GB)

(21) Appl. No.: 19/073,440

(22) Filed: Mar. 7, 2025

(51) Int. Cl. G06F 9/48; G06F 9/30

(52) U.S. Cl. CPC G06F 9/4881; G06F 9/30065

(57) ABSTRACT

An apparatus comprising storage, an execution unit and a handling unit. The handling unit is configured to obtain task data that describes a task to be executed. The task comprises a plurality of operations representable as a directed graph of operations comprising operations connected by connections corresponding to respective logical storage locations. The task data comprises value selection data for use in selecting value data representing a value for use in executing an operation of the operations. The operation comprises processing input data from an input logical storage location of the logical storage locations with the value data. The handling unit is configured to use the value selection data to select the value data and dispatch invocation data, based on the task data and the value data, to the execution unit to cause the execution unit to execute the operation.

### BACKGROUND

### Technical Field

The disclosure herein relates to apparatuses and methods for use in executing an operation, such as a data processing operation.

### Description of the Related Technology

Certain data processing techniques, such as neural network processing and graphics processing, involve the processing and generation of considerable amounts of data using operations. It is desirable to handle data such as this in an efficient and/or flexible manner.

### SUMMARY

According to a first aspect of the present disclosure, there is provided an apparatus comprising storage, an execution unit and a handling unit, wherein the handling unit is configured to: obtain task data that describes a task to be executed, the task comprising a plurality of operations representable as a directed graph of operations comprising operations connected by connections corresponding to respective logical storage locations, wherein the task data comprises value selection data for use in selecting value data representing a value for use in executing an operation of the operations, the operation comprising processing input data from an input logical storage location of the logical storage locations with the value data; use the value selection data to select the value data; and dispatch invocation data, based on the task data and the value data, to the execution unit to cause the execution unit to execute the operation.

According to a second aspect of the present disclosure, there is provided a method comprising: obtaining, by handling circuitry, task data that describes a task to be executed, the task comprising a plurality of operations representable as a directed graph of operations comprising operations connected by connections corresponding to respective logical storage locations, wherein the task data comprises value selection data for use in selecting value data representing a value for use in executing an operation of the operations, the operation comprising processing input data from an input logical storage location of the logical storage locations with the value data; using, by the handling circuitry, the value selection data to select the value data; and dispatching, by the handling circuitry, invocation data, based on the task data and the value data, to execution circuitry for execution of the operation.

### BRIEF DESCRIPTION OF THE DRAWINGS

FIG. 1 is a flow diagram of a method of selecting value data according to an example;

FIG. 2 is a schematic representation of an example apparatus;

FIG. 3 is a schematic diagram illustrating derivation of value data according to an example;

FIG. 4 is a schematic diagram illustrating derivation of value data according to a further example;

FIG. 5 is a schematic diagram illustrating derivation of value data according to a still further example;

FIG. 6a illustrates an example directed graph;

FIG. 6b is a schematic diagram of a data processing system;

FIG. 7a is a schematic diagram of an example neural engine;

FIG. 7b is a schematic diagram showing components of a vector engine;

FIG. 8 is a schematic diagram of an example system for allocating handling data;

FIG. 9 is a schematic representation of a simulator implementation according to an example; and

FIG. 10 is a schematic diagram of manufacture of a system and a chip-containing product.

### DETAILED DESCRIPTION

### Value Data Selection

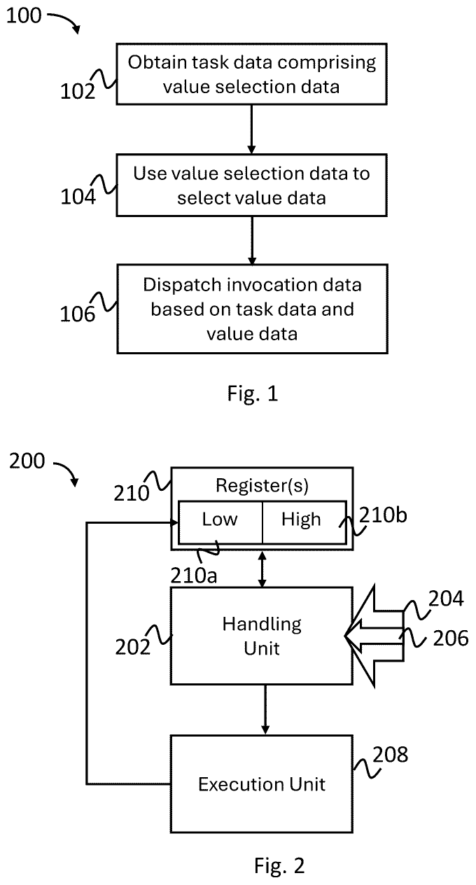

FIG. 1 is a flow diagram 100 showing a method of selecting value data. The method may be performed by a handling unit of an apparatus comprising storage and an execution unit. The handling unit may be implemented by handling circuitry so that the method is executed by the handling circuitry. The execution unit may be implemented by execution circuitry, which may be considered to be an example of processing circuitry.

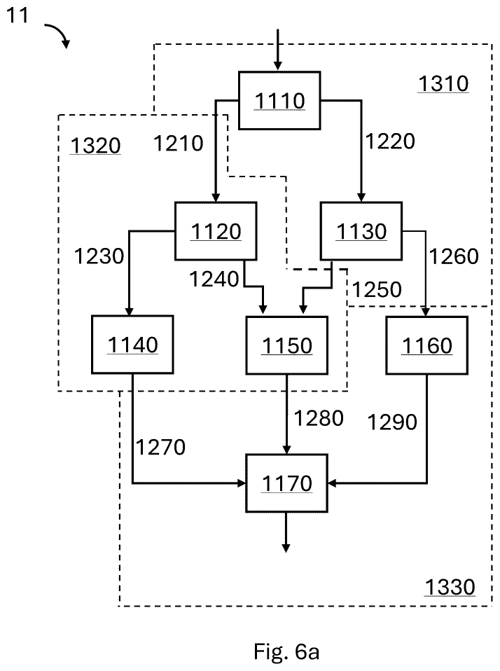

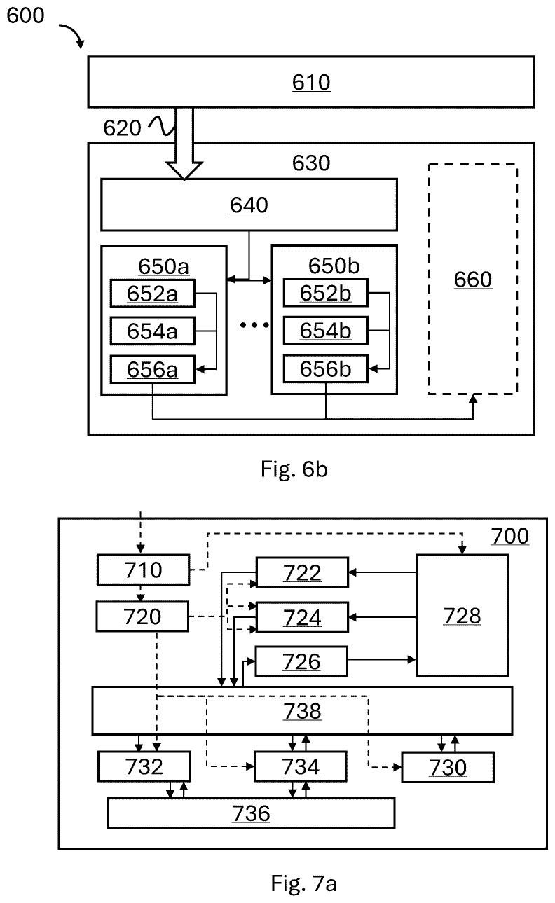

At item 102 of the flow diagram 100, task data that represents a task to be executed is obtained. The task comprises a plurality of operations representable as a directed graph of operations, as explained further with reference to FIG. 6a. The directed graph comprises operations connected by connections corresponding to respective logical storage locations (e.g. corresponding to respective logical addresses of physical storage locations). The task data comprises value selection data for use in selecting value data representing a value for use in executing an operation of the operations. The operation comprises processing input data from an input logical storage location of the logical storage locations with the value data. The value selection data can be used to determine which data is to be selected as the value data that is to be processed with the input data.

At item 104, the value selection data is used to select the value data. This allows the value data to be selected in a flexible manner, for example without changing a configuration of the execution unit that is to process the value data in executing the operation. For example, the value data can be selected in a hardware efficient manner, without adjusting how downstream components that utilize the value data (such as the execution unit) operate. For example, the value selection data can be used to select between using a field of the task data as the value data or using other data, which is not provided as a field of the task data but is instead provided separately from the task data, as the value data. The other data may be derived value data, which is derived from at least a portion of the task data, e.g. by processing at least the portion of the task data using the handling unit. This allows different values (represented by different value data) to be selected for processing with the input data, based on the value selection data, in a straightforward manner.

At item 106, invocation data, based on the task data and the value data, is dispatched to the execution unit to cause the execution unit to execute the operation. The invocation data for example includes, or otherwise indicates, the data that is to be processed in executing the operation (including the input data and the value data). For example, the invocation data may include the value data itself or a pointer to the value data to allow the value data to be obtained from storage by the execution unit. The invocation data may also or instead include the value selection data, to allow for further flexibility. Offloading management of the execution of the task, such as dividing the task into blocks to be processed iteratively, from the execution unit to other components of the apparatus enables a simpler configuration to be used for the execution unit. For example, the execution unit may be a dedicated unit that is dedicated to performing a particular type of operation.

FIG. 2 is a schematic representation of an apparatus 200 for selecting value data, for example as described above in relation to the flow diagram 100 of FIG. 1. The apparatus 200 comprises a handling unit 202 configured to obtain task data 204. The task data 204 comprises value selection data 206. The apparatus 200 further comprises an execution unit 208 and register(s) 210. The apparatus 200 may also comprise storage (not shown), e.g. a storage medium, such as a solid-state drive (SSD) or other semiconductor-based RAM; a ROM, for example, a CD ROM or a semiconductor ROM; a magnetic recording medium, for example, a floppy disk or hard disk; optical memory devices in general; etc. In some examples, the register 210 may form part of this storage medium.

The task data 204 is indicative of a task to be executed. As explained with reference to FIG. 1, the task comprises operations representable as a directed graph of operations. In this example, the task data 204 defines a multi-dimensional nested loop defining an operation space. The handling unit 202 is configured to iterate over the operation space in blocks. Respective blocks in the operation space may be referred to herein as operation blocks. The execution unit 208 is configured, by invocation data sent by the handling unit 202, to execute at least an operation of the operations. The operation comprises processing of input data with value data selected by the handling unit 202 based on the value selection data 206 of the task data 204.

In FIG. 2, the operation space is defined by data stored in the registers 210, which in this example are boundary registers. The registers 210 comprise a respective register for each dimension of the dimensions of the multi-dimensional nested loop. For a particular block in the operation space, each register 210 comprises a low portion 210a storing a low bound of the block for the corresponding dimension, and a high portion 210b storing a high bound of the block for that dimension. The values stored in the low and high portions 210a, 210b of the register 210 for a given dimension thus define a range of the block in that dimension. Hence, the register 210 for a given dimension may be considered to store range data defining the range of a block in the given dimension.

In FIG. 2, the handling unit 202 is configured to perform a procedure to map each block of the plurality of blocks that are iterated over in the operation space to a different respective local block in a local space (which is for example a space that is specific to the operation that is to be performed, and that comprises processing the value data with the input data). This procedure may be referred to as a mapping procedure, and in this example comprises updating data stored in at least one of the registers 210 to store transformed data in at least one of the boundary registers 210. The transformed data defines a local block to which a particular (operation) block is mapped.

For example, a range of a boundary register for dimension d may be represented by a low (b[d].lo) and a high (b[d].hi) signed component of the boundary register. In other words, the low and high portions 210a, 210b of each of the registers 210 of FIG. 2 may store the b[d].lo and b[d].hi values, respectively, for the corresponding dimension, d, in the operation space, prior to performing the mapping procedure. Upon executing the mapping procedure, the low and high bounds of the outer dimension (i.e. the b[d].lo and b[d].hi values) may be updated for at least one of the dimensions.

The local block in the local space may be lower dimensional than the block in the operation space. In FIG. 2, the local block comprises dimensions 0 to (n−1), but there are m registers in total (for dimensions 0 to (m−1) of the block in the operation space, where m is greater than n). This means that, after executing the mapping procedure, registers n to (m−1) are unused in defining the local block. These registers can be used to store the value data to be used in executing the operation.

In examples such as that of FIG. 2, the value selection data is stored in a corresponding value selection field of the task data, and has a state indicative of which data is to be selected as the value data. For example, the value selection data may take one of a predetermined set of states, to indicate which of a predetermined set of data is to be selected as the value data. In one case, the value selection data represents a binary value. In this case, a binary value of 0 may be used to indicate that the value data is encoded in (e.g. comprised by) the task data (such as in a field of the task data) and a binary value of 1 may be used to indicate that the value data is derived value data, which is to be derived by the handling unit 202 from at least a portion of the task data (or vice versa). It is to be appreciated, though, that this is merely an example and the value selection data may be set to other predetermined numbers or other states to indicate which data is to be selected as the value data.

In one example, the value selection data indicates that a field of the task data is to be selected as the value data. In response to this indication by the value selection data (e.g. in response to the handling unit 202 determining that the value selection data has a state, such as a binary of value 0, corresponding to this indication), the handling unit 202 retrieves the field of the task data as the value data. The handling unit 202 then uses the value data to dispatch invocation data to the execution unit 208 to execute the operation comprising processing input data with the value data. For example, the handling unit 202 may send the value data itself to the execution unit 208 (as part of the invocation data) or may instead send a pointer to the value data to allow the execution unit 208 to retrieve the value data.

In another example, the value selection data indicates that the handling unit 202 is to select derived value data as the value data. The handling unit 202 is configured to derive the value data by processing at least a portion of the task data. In this example, the handling unit 202 iterates over the operation space in blocks, and derives the derived value data on a per-block basis for a plurality of the blocks.

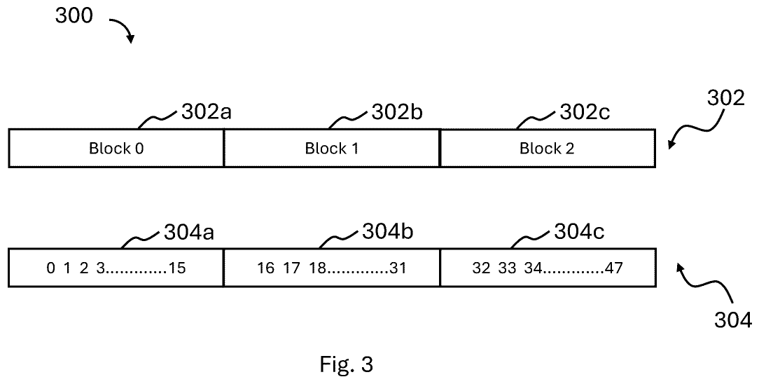

The derived value data for a particular block may be based on a position associated with the particular block, within the operation space. This can allow position-dependent values to be determined in a straightforward way. For example, the position associated with the particular block may be indicative of an element position of a predefined element of the particular block within the operation space and/or a relative element position of the predefined element of the particular block relative to a predefined reference element of a reference block within the operation space. In general, the position may be representable using at least one coordinate. Each of the at least one coordinate indicates the position in a different respective dimension of the operation space. In these examples, the derived value data may be based on a linear function of the at least one coordinate. Examples in which the derived value data depends on the position associated with a particular block are discussed in more detail with reference to FIGS. 3 to 5.

The derived value data may be derived as part of the procedure to map each block of the plurality of blocks that are iterated over in the operation space to a different respective local block in a local space. This mapping procedure for example operates on range data defining the range of a particular block in the operation space. The range (or a component of the range, such as a lower or upper bound of the range) may be used as or to define the position associated with the particular block. For example, a coordinate indicating a particular element (e.g. a top-left element) of the block may be taken as the position, and may be calculated from the range used during application of the mapping procedure to the particular block. Deriving the derived value data during the mapping procedure can thus utilize data that is already used in performing the mapping procedure (which is indicative of the position associated with the particular block), without having to recalculate the position, which is more computationally efficient.

In the example in which the derived value data is selected as the value data, the handling unit 202 writes the value data (which in this case is the derived value data) to an unused register (e.g. register n) of the boundary registers 210. The value data may be written to the low portion 210a and/or the high portion 210b of the unused register. The boundary registers 210 may be accessed relatively rapidly by the handling unit 202, allowing the derived value data to be written to and retrieved from the boundary registers 210 efficiently.

In a further example in which the value selection data indicates that the handling unit 202 is to select derived value data as the value data, the derived value data for a particular block is independent of the position associated with the particular block in the operation space. In this case, the derived value data may nevertheless be derived for the particular block based on a portion of the task data, and may represent different numerical values for different respective blocks. This provides further flexibility, to enable a wider range of operations to be executed using the value data.

Irrespective of whether the derived value data for a particular block depends on the position associated with the particular block, the handling unit 202 in these examples then sends the invocation data to the execution unit 208 based on the task data and the value data. In this case, the handling unit 202 may retrieve the value data from the register to which it was written and send the value data to the execution unit 208 (e.g. as part of the invocation data) and/or the handling unit 202 may send, to the execution unit 208, a pointer to the value data in the register (e.g. as part of the invocation data).

The execution unit 208 uses the value data to execute the operation. The operation may be a broadcast operation, in which the same value (represented by the value data) is processed with each of a plurality of elements of a particular input block. In other words, where the operation comprises processing input blocks of data, the operation may comprise processing each of a plurality of elements of the particular input block, respectively, with the value represented by the value data. The use of the value selection data for example provides flexibility in selecting a value for use in a broadcast operation applied to a particular input block of data (e.g. representing a block in an operation space, such as a block of a multi-dimensional tensor).

### Examples of Deriving Value Data

FIG. 3 shows a schematic example 300 of deriving value data, which in this case can be used in the execution of a so-called “arange” operation, which is a function to return evenly spaced values across a particular range. This operation may be used for various data processing operations, including machine learning processing. The example 300 of FIG. 3 illustrates the creation of a one-dimensional (1D) array in which an Nth element of the array contains the value N. However, in other cases, a similar operation may be used to create 1D or multi-dimensional arrays with elements containing other values that are nevertheless linear functions of the element coordinate.

The example 300 of FIG. 3 illustrates the creation of an array of 48 elements (labelled from 0 to 47) containing numbers corresponding to the element label (i.e. so element 0 contains 0, element 1 contains 1 and so on). The array is divided into three blocks 302: a first, second and third block 302a, 302b, 302c (indicated as Block 0, Block 1 and Block 2 in FIG. 3).

The values 304 of respective elements of the blocks 302 are also indicated in FIG. 3. There are 16 elements in each of the blocks 302. The 16 elements of the first block 302a have a first set of values 304a, from 0 (for element 0), 1 (for element 1), 2 (for element 2) and so on, up to 15 (for element 15), i.e. such that the first set of values 304a is 0, 1, 2, 3 . . . 15. The 16 elements of the second block 302b have a second set of values 304b of 16, 17, 18 . . . 31 and the 16 elements of the third block 302c have a third set of values 304c of 32, 33, 34 . . . 47.

The array of values 304 can be generated in an efficient manner using the same hardware arrangement to generate the set of values 304a-304c for each of the blocks 302. In this example, the first set of values 304a are stored in storage and can then be retrieved and used to generate the second and third sets of values 304b, 304c based on the position of the elements in the second and third blocks 302b, 302c relative to the first block 302a. In this example, there is a difference of 16 between the values of each element of the second block 302b and a corresponding element of the first block 302a. Hence, the value of element 0 of the second block 302b (16) can be obtained by adding 16 to the value of element 0 of the first block 302a (0), and so forth. Similarly, there is a difference of 32 between the values of each element of the third block 302c and a corresponding element of the first block 302a, such that the value of element 0 of the third block 302c (32) can be obtained by adding 32 to the value of element 0 of the first block 302a (0).

The values of 16 and 32 that are added to the first set of values 304a to obtain the second and third sets of values 304b, 304c may be considered broadcast values. To generate a given set of values (e.g. the second or third sets of values 304b, 304c) the same value (16 or 32 for the second or third sets of values 304b, 304c respectively) is added to each value of the first set of values 304a. These broadcast values are examples of derived values, which are derived by the handling unit and are represented by derived value data. These derived values depend on the position associated with a particular block. In this case, the derived values depend on the position of the first element of each block subsequent to the first block 302a. The first element of the first block 302a has a coordinate of x in a given dimension (in the operation space), meaning that the first elements of the second and third blocks 302b, 302c have coordinates of x+16 and x+32 respectively in this dimension (where x is zero in this example, for simplicity). This can be expressed as x+16B, where B is the block number, with B taking a value of 0 for Block 0 302a, 1 for Block 1 302b and 2 for Block 2 302c. The derived value data for the second block 302b represents a derived value of 16 and the derived value data for the third block 302c represents a derived value of 32, which is derived by the handling unit and represents the position of the first elements of the second and third blocks 302b, 302c relative to the position of the first element of the first block 302a, in the given dimension.

In FIG. 3, the handling unit sends invocation data to an execution unit configured to process input data representing the first block 302a with the derived value data in order to generate the second and third blocks 302b, 302c. The derived value represented by the derived value data is broadcast so that the same derived values of 16 and 32 are added to each element of the first block 302a in order to generate each element of the second and third blocks 302b, 302c, respectively. Accordingly, the second and third blocks 302b, 302c are generated based on the same reference block (the first block 302a), which can reduce the amount of data transferred and stored compared to generating different blocks based on different reference blocks.

The expression of x+16B, from which the derived values for a particular block can be obtained, is an example of a linear function of at least one coordinate for representing the position associated with the particular block. In this example, the position associated with the particular block represents a relative element position of a predefined element of the particular block (in this case, the position of the first element in the particular block) relative to a predefined reference element of a reference block (in this case, the first element of the first block 302a). This position can be expressed using the linear function of x+16B, discussed above. The derived value of 16 for the second block 302b is based on this linear function, and in this case is derived by determining the value of x+16B for B=1, i.e. for the second block 302b. Similarly, the derived value of 32 for the third block 302c is also based on this linear function, and in this case is derived by determining the value of x+16B for B=2, i.e. for the third block 302c. The derived value for the third block 302c may be referred to as a further derived value represented by further derived value data, which is nevertheless derived based on the same linear function as that used to derive the derived value for another block (in this case, the second block 302b), but taking into account the relative positions of each of the blocks with respect to the first block 302a.

Using a derived value for each respective block allows the blocks to be generated in a hardware efficient manner. For example, the same hardware configuration of the execution unit can be used to generate each block, but operating on a different derived value, which can be selected flexibly using the value selection data described herein.

It is to be appreciated that at least one additional operation may be applied to a block after generation of the block using the value data described herein. For example, a block may be generated and then each element of the block may be squared (or processed using a non-linear function) to generate a block with a non-linear pattern of element values.

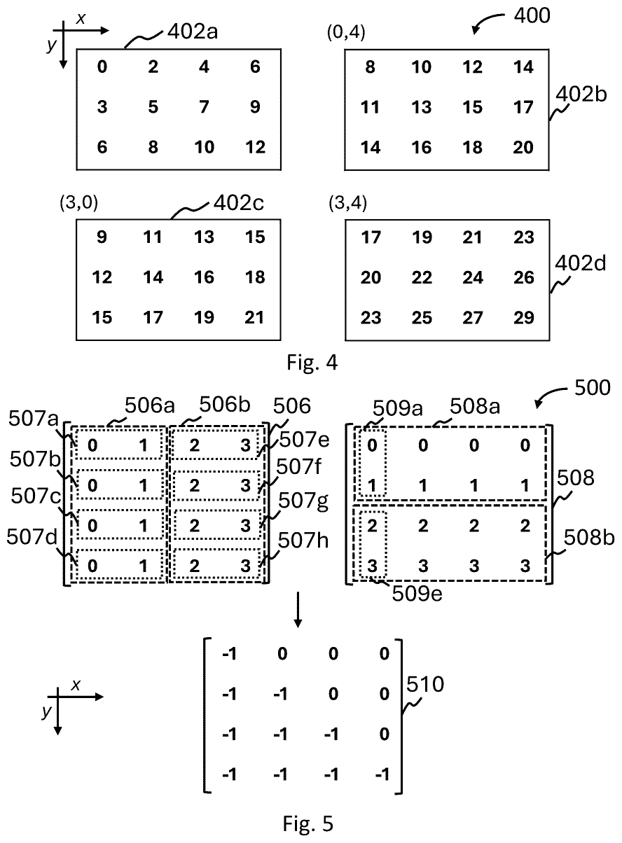

FIG. 4 illustrates a further example 400 of deriving value data using a similar approach to that of FIG. 3, but in two dimensions and using a different linear function of coordinates associated with a particular block. The two dimensions are labelled x and y in FIG. 4 and are orthogonal to each other, with the x-dimension corresponding to a horizontal dimension and the y-dimension corresponding to a vertical dimension in the orientation of FIG. 4. Four blocks 402a-d are shown in FIG. 4, with each block having 4 elements in the x-direction and 3 elements in the y-direction. The values of each element of each block can be expressed using the linear function of 2x+3y. Given the block size of 4 by 3, the values of respective elements of a particular block relative to the first block 402a (which can be considered a reference block) can be expressed based on the coordinate of the first element (with the lowest x and y value) in the block. For the second block 402b, the coordinate of the first element is (0, 4), and a derived value to be added to each element of the first block 402a to obtain the values of respective elements of the second block 402b can be calculated as 2x+3y evaluated for the x and y values of the first element of the second block 402b (i.e. 4 and 0 respectively). In this case, the derived value is 8 for the second block 402b, which can be added to each corresponding element of the first block 402a to obtain the values for the second block 402b during execution of the 2D “arange” operation shown in FIG. 4. The derived value of 8 is added to the value of the first element of the first block 402a of 0 to obtain the value of the first element of the second block 402b of 8, and so on.

Similarly, the coordinate of the first element of the third block 402c is (3, 0), meaning that the derived value for the third block 402c (2x+3y evaluated for the x and y values of 0 and 3 respectively) is 9. The coordinate of the first element of the fourth block 402d is (3, 4), meaning that the derived value for the fourth block 402d (2x+3y evaluated for the x and y values of 4 and 3 respectively) is 17. The derived values for the third and fourth blocks 402c, 402d are added to each corresponding element of the first block 402a to obtain the values for the third and fourth blocks 402c, 402d.

FIG. 5 illustrates a further example 500 of deriving value data in the two dimensions (labelled x and y) shown in FIG. 4. In the example 500 of FIG. 5, the derived value data is used in executing an operation to generate a mask output 510, which is an arrangement of values (e.g. an array, a matrix or a tensor) that indicate whether a particular element of set of data to be operated on (which is for example also an array, matrix or tensor) is to be set in an on or an off state and/or to invert a state of a particular element, such as a bit, of the data to be operated on. For example, a mask output (which may be referred to as a mask or a bitmask) may be used for bitwise operations. The mask output may comprise an arrangement of values that take a particular value (e.g. zero) for setting a corresponding element to an off state and a different value (e.g. a non-zero value, such as one or an integer 2's complement value of −1) for setting a corresponding element to an on state.

In FIG. 5, the derived value data is used to generate a lower triangular mask output 510, which in this example is a 2D, 4 by 4 array of values, with elements on a diagonal of the mask output 510 and below the diagonal from the lowest to the highest x and y values in the orientation of FIG. 5 (i.e. with y values equal to or larger than those on the diagonal) having a value of 1 and the remaining elements having a value of 0.

In FIG. 5, a first output tensor 506 is generated. Each element of the first output tensor 506 at coordinate (x,y) has the value x. The first output tensor 506 is generated on a block-by-block basis, for example using the “arange” operation, as described in more detail with reference to FIGS. 3 and 4. The first output tensor 506 comprises first and second output blocks 506a, 506b, each of which is generated based on the processing of each of a plurality of elements of a particular input block, respectively, with a respective value selected in accordance with examples here (which may be a derived value as per FIGS. 3 and 4).

In this example, the first and second output blocks 506a, 506b each comprise first to fourth sub-blocks 507a-507d, 507e-507h, which are each 1D sub-blocks comprising two elements in the x direction. The first sub-blocks 507a, 507e of the first and second output blocks 506a, 506b are generated by adding respective values to a reference block (which is an example of a particular input block). In this example, the reference block is a 1D block comprising the values: [0 1]. The first sub-blocks 507a, 507e of the first and second output blocks 506a, 506b (corresponding to a top-left and top-right set of 2 elements in the uppermost row of the first output tensor 506, at the lowest y value) can be obtained by adding different respective derived values to the reference block. The derived values to be added for the first sub-blocks 507a, 507e of the first and second output blocks 506a, 506b can be expressed as a linear function of the output block position (e.g. expressed as an output block number, n, such that the first and second output blocks 506a, 506b are numbered 0 and 1). In FIG. 5, this linear function for generating the first sub-blocks 507a, 507e of the first and second output blocks 506a, 506b can be expressed as 2n, so that the derived values for the first sub-blocks 507a, 507e of the first and second output blocks 506a, 506b are 0 and 2, respectively. Generating first sub-blocks 507a, 507e of the first and second output blocks 506a, 506b in this case involves adding a particular value (the derived values of 0 and 2, respectively) to each of the elements in a first dimension (the x dimension) of the particular input block (the reference block comprising the values: [0 1]). This generates first and second sets of element values for the first sub-blocks 507a, 507e of the first and second output blocks 506a, 506b (the values [0 1] and [2 3], respectively). The first and second sets of element values for the first sub-blocks 507a, 507e have first and second precursor patterns in the first dimension, which are for example respective precursors to a pattern to be generated in the output blocks generated using the respective first sub-blocks 507a, 507b. The first and second precursor patterns may be expressed using a function, which may be a function of the element position, e.g. a linear function of the element function.

To generate the first output block 506a of the first output tensor 506, the first precursor pattern of [0 1] is broadcast to each of at least one further dimension of the first output block 506a. The at least one further dimension comprises (and, in this case, is) a second dimension, which in FIG. 5 is the y-dimension. This involves re-using the first precursor pattern of the first sub-block 507a for each of the other sub-blocks 507b-507d in the second dimension (i.e. in the y direction in this case), so as to generate the first output block 506a. In the first output block 506a, each of the sub-blocks (which are each at a different position in the y-dimension) has the same values as each other, due to the broadcasting of the first precursor pattern of the first sub-block 507a to each of the other sub-blocks 507b-507d. The second output block 506b is generated similarly, by broadcasting the second precursor pattern of [2 3] of the first block 507e of the second output block 506b to each other sub-block 507f-507h of the second output block 506b (which are each at a different respective position in the y-dimension of FIG. 5). Broadcasting the first and second precursor patterns to generate the first and second output blocks 506a, 506b may be more efficient than individually calculating respective elements or sub-blocks of elements of the first and second output blocks 506a, 506b.

In this way, respective output blocks of the first output tensor 506 can each be generated in accordance with a first pattern. The first pattern for example represents a particular arrangement of values within a given output block. The value of particular elements in a particular output block according to a first pattern may be expressed using a particular function, which may be a function of the element position, e.g. a linear function of the element position. In FIG. 5, the value of respective elements of the first output tensor 506 can be expressed as the value of element (x, y)=x.

Each element of the second output tensor 508 at coordinate (x,y) has the value y. The second output tensor 508 may be generated by transposing the first output tensor 506. In this case, the second output tensor 508 (and respective blocks thereof) may nevertheless considered to be based on the processing of each of the plurality of elements of a particular input block (e.g. the reference data) with the value represented by the value data, in that this processing is used to generate the first output tensor 506, which is then transposed to obtain the second output tensor 508.

In the example of FIG. 5, though, the second output tensor 508 is generated in a similar way to the first output tensor 506, but by broadcasting sub-block values in the x-direction rather than in the y-direction. This for example provides greater flexibility in generating the second pattern of second element values of the second output tensor 508, for example to generate a second pattern which is not a transpose of the first pattern. The second output tensor 508 of FIG. 5 comprises first and second output blocks 508a, 508b, each of which is generated based on the processing of each of a plurality of elements of the particular input block for generating the first output tensor 506 and/or a further input block with a different respective value (which in this example is a derived value). The respective values used for generating the first and second output blocks 508a, 508b of the second output tensor 508 may be the same as those used for generating the first and second output blocks 506a, 506b of the first output tensor 506, respectively. Alternatively, the first and second output blocks 508a, 508b of the second output tensor 508 may be generated based on the processing of each of a plurality of elements of the particular input block and/or the further input block with a different respective further value than those used for generating the first output tensor 506. For example, each of the output blocks of the first and second tensors 506, 508 may be generated based on an independently-generated value, which may be generated on a block-by-block basis and may differ for different output blocks. In FIG. 5, the first and second output blocks 508a, 508b are based on processing of a transposed version of the reference block for use in generating the first output tensor 506, which can be expressed as:

$$[ \begin{matrix}0 \\ 1\end{matrix} ] .$$

To generate the first and second output blocks 508a, 508b, first sub-blocks 509a, 509e of the first and second output blocks 508a, 508b are generated by adding respective values to the reference block of

$$[ \begin{matrix}0 \\ 1\end{matrix} ] .$$

The first sub-blocks 509a, 509e of the first and second output blocks 508a, 508b are top-left and bottom-left sets of 2 elements in the leftmost column of the second output tensor 508. The derived values to be added for the first sub-blocks 509a, 509e of the first and second output blocks 508a, 508b of the second output tensor 508 can be expressed as a linear function of the output block position (e.g. expressed as an output block number, n, such that the first and second output blocks 508a, 508b are numbered 0 and 1). In FIG. 5, this linear function for generating the first sub-blocks 509a, 509e of the first and second output blocks 508a, 508b can be expressed as 2n, so that the derived values for the first sub-blocks 509a, 509e of the first and second output blocks 508a, 508b are 0 and 2, respectively. Generating first sub-blocks 509a, 509e of the first and second output blocks 508a, 508b in this case involves adding a particular value (the derived values of 0 and 2, respectively) to each of the elements in a second dimension (the y dimension) of the particular input block (the reference block of

$$[ \begin{matrix}0 \\ 1\end{matrix} ] ) .$$

This generates first and second sets of element values for the first sub-blocks 509a, 509e of the first and second output blocks 506a, 506b of

$$[ \begin{matrix}0 \\ 1\end{matrix} ] and [ \begin{matrix}2 \\ 3\end{matrix} ] ,$$

respectively. The first and second sets of element values for the first sub-blocks 509a, 509e have first and second precursor patterns in the second dimension, which are for example respective precursors to a pattern to be generated in the output blocks generated using the respective first sub-blocks 509a, 509b. Similarly to the precursor patterns described with reference to the first output tensor 506, these first and second precursor patterns may be expressed using a function, which may be a function of the element position, e.g. a linear function of the element function.

To generate the first output block 508a of the second output tensor 508, the first precursor pattern of

$$[ \begin{matrix}0 \\ 1\end{matrix} ]$$

is broadcast to each of at least one further dimension of the first output block 508a of the second output tensor 508. The at least one further dimension comprises (and, in this case, is) the first dimension, which in FIG. 5 is the x-dimension. This involves re-using the first precursor pattern of the first sub-block 509a for each of a plurality of other sub-blocks in the x-dimension (not labelled in FIG. 5, for clarity), so as to generate the first output block 508a of the second output tensor 508. In the first output block 508a, each of the sub-blocks (which are each at a different position in the x-dimension) has the same values as each other, due to the broadcasting of the first precursor pattern of the first sub-block 509a to each of the other sub-blocks. The second output block 508b of the second output tensor 508 is generated similarly, by broadcasting the second precursor pattern of

$$[ \begin{matrix}2 \\ 3\end{matrix} ]$$

of the first block 509e of the second output block 508b to each other sub-block of the second output block 508b (which are each at a different respective position in the y-dimension of FIG. 5 and are not labelled in the Figure, for clarity).

In this way, respective output blocks of the second output tensor 508 can each be generated in accordance with a second pattern, which, as for the first pattern, may be expressed using a particular function, such as a function of the element position, e.g. a linear function of the element position. In FIG. 5, the value of respective elements of the second output tensor 508 can be expressed as the value of element (x, y)=y.

It is to be appreciated that this is merely an example of generating first and second output blocks for first and second output tensors using values selected according to methods herein, and other methods may be used to generate the first and second output tensors 506, 508 shown in FIG. 5.

For example, respective blocks of the first and second output tensors 506, 508 may be generated based on a 2 by 2 reference block comprising the values:

$$[ \begin{matrix}0 & 1 \\ 0 & 1\end{matrix} ]$$

In this example, first to fourth output blocks of the first output tensor 506 (corresponding to a top-left, top-right, bottom-left and bottom-right set of 2 by 2 elements of the first output tensor 506, respectively) are generated by adding different respective derived values to the reference block. The derived values to be added for a particular output block of the first output tensor 506 can be expressed as a linear function of the coordinate of the first element of the particular output block (with the lowest x and y) values as 2x, so that the derived values for the first to fourth output blocks are 0, 2, 0, 2, respectively. Similarly, the derived values to be added for a particular output block of the second output tensor 508 can be expressed as a linear function of the coordinate of the first element of the particular output block (with the lowest x and y) values as 2y, so that the derived values for first to fourth output blocks (with the same coordinates as the first to fourth output blocks of the first output tensor 506 in this example) are 0, 0, 2, 2, respectively.

The first and second output tensors 506, 508 are used to generate the mask output 510, which is itself a tensor. The mask output 510 is generated by performing an elementwise comparison of the first and second output tensors 506, 508. This may involve calculating respective mask output blocks (corresponding to blocks of elements of the mask output 510) by performing an elementwise comparison of at least part of an output block of the first output tensor 506 and a corresponding at least part of an output block of the second output tensor 508 or performing an elementwise comparison of the first and second output tensors 506, 508 themselves. An elementwise comparison is for example performed between output blocks (or corresponding parts thereof) of the same shape and size. If each respective output block of the first and second output tensors 506, 508 is a 2 by 2 block, an elementwise comparison may be performed between each element of corresponding output block of the first and second output tensors 506, 508. However, if output blocks of the first and second output tensors 506, 508 are 4 by 2 and 2 by 4 blocks, respectively, an elementwise comparison may be performed for the respective elements in common between corresponding blocks in the first and second output tensors 506, 508. In FIG. 5, the elementwise comparison of the first and second output tensors 506, 508 involves comparing corresponding elements of the first and second output tensors 506, 508, which in this example are both blocks of 4 by 4 elements. If the value of a particular element of the first output tensor 506 is greater than the value of a corresponding element of the second output tensor 508, setting the value of the corresponding element of the mask output 510 to zero. Conversely, if the value of a particular element of the first output tensor 506 is less than or equal to the value of a corresponding element of the second output tensor 508, the value of the corresponding element of the mask output 510 is set to an integer 2's complement value of −1, which has all its bits set

It is to be appreciated that FIG. 5 merely shows an example 500 of a mask output 510 that can be generated. For example, an inverse to the mask output 510 of FIG. 5 could be generated by setting the value of a particular element of the mask output 510 to an integer 2's complement value of −1 if the value of the corresponding element of the first output tensor 506 is greater than the value of the corresponding element of the second output tensor 508, and to zero otherwise.

A mask output such as the mask output 510 may be used for various purposes in data processing, e.g. for machine learning processing. For example, a transformer (which is a type of neural network architecture) may use a causal mask, which can be obtained efficiently using the approach of FIG. 5. For example, a causal mask may be used to mask future words of a sequence (e.g. represented by tokens) that are ahead of a current position within the sequence during training of the transformer to predict a subsequent word in a sequence based on previous words, so that the transformer is unable to use future words in predicting the next word of a given training sequence. However, this is merely one example of many possible applications of mask outputs in data processing.

### Execution of a Directed Graph

Many data structures to be executed in a processor can be expressed as a directed graph. Examples of such data structures include neural networks which can be represented as a directed graph of operations that wholly compose the operations required to execute a network (i.e. to execute the operations performed across the layers of a neural network). A directed graph of operations may comprise an operation comprising processing of value data as described above with reference to FIGS. 1 to 5. Examples involving a directed graph of operations will now be described.

A directed graph is a data structure of operations (which may be referred to herein as ‘sections’) having directed connections therebetween that indicate a flow of operations. The connections between operations (or sections) present in the graph of operations may be referred to as pipes (where a given connection is the sole tenant of a particular region of the storage unit, which region may be allocated to that connection statically or dynamically) or sub-pipes (where a given connection shares a particular region of the storage unit with at least one other connection). The allocation of particular storage elements within a given region of the storage unit to different respective sub-pipes that are tenants of the given region of the storage unit may be performed dynamically. A plurality of sub-pipes may belong to the same pipe as each other, which may be referred to as a multi-pipe. In such cases, the multi-pipe may be the sole tenant of the given region of the storage unit, which may itself be statically or dynamically allocated to the multi-pipe. A directed graph may contain any number of divergent and convergent branches. A directed graph may contain any number of divergent and convergent branches.

FIG. 6a illustrates an example directed graph 11 in which sections are interconnected by pipes or sub-pipes. Specifically, an initial section, section 1 (1110) represents a point in the directed graph at which an operation, operation A, is to be performed when executing the graph. The output of operation A at section 1, 1110, is connected to two further sections, section 2 (1120) and section 3 (1130) at which respective operations B and C are to be performed. The connection between section 1 (1110) and section 2 (1120) can be identified as a pipe with a unique identifier, pipe 1 (1210). The connection between section 1 (1110) and section 3 (1130) can be identified as a pipe with a different unique identifier, pipe 2 (1220). The output of section 1, which is the result of performing operation A on the input to section 1, can be provided to multiple subsequent sections in a branching manner.

More generally, sections in the directed graph may receive multiple inputs, each from a respective different section in the directed graph via a respective different pipe or sub-pipe. In FIG. 6a, sections 2 and 3 (1120, 1130) each write to different respective sub-pipes (1230, 1240, 1250, 1260) of the same pipe, pipe 3, which is a multi-pipe. Each sub-pipe has its own unique identifier, which also indicates the multi-pipe to which the sub-pipe belongs, where a multi-pipe is a pipe comprising at least one sub-pipe, as explained above. In this case, section 2 writes to sub-pipes 3.0 and 3.1 (1230, 1240) and section 3 writes to sub-pipes 3.2 and 3.3 (1250, 1260), where the numeral prior to the period indicates the identifier of the multi-pipe (3) and the numeral after the period indicates the identifier of the sub-pipe of the multi-pipe (0 to 3 in this case). A region of a storage unit is allocated to multi-pipe 3, and respective storage elements of the region of the storge unit are dynamically allocated to sub-pipes 3.0 to 3.3. In this example, different sections (sections 2 and 3) thus write to the same underlying physical region of the storage unit, via dynamically allocated sub-pipes.

The directed graph 11 of FIG. 6a also includes sections 4 to 6 (1140 to 1170) and pipes 4 to 6 (1270 to 1290). The sections 4 and 6 (1140, 1160) receive input data from sub-pipes 3.0 and 3.3 (1230, 1260) respectively, and write data to pipes 4 and 6 (1270, 1290) respectively. Section 5 (1150) in FIG. 6a receives a first set of input data via sub-pipe 3.1 (1240) from section 2 (1120) and a second set of input data via sub-pipe 3.2 (1250) from section 3 (1130) and writes data to pipe 5 (1280). Section 7 (1170) of the directed graph 11 receives input data from pipes 4 to 6 (1270 to 1290). Depending on the nature of the operation performed in a particular section and the dependencies of subsequent operations on the output of the operation, any number of input and output pipes may be connected to a particular section in the directed graph.

The directed graph can be represented by a number of sub-graphs each containing a subset of the sections in the graph. FIG. 6a illustrates an arrangement where the graph 11 is broken down into three sub-graphs 1310, 1320, and 1330 which can be connected together to form the complete graph. For example, sub-graph 1310 contains sections 1 and 3 (1110 and 1130) as well as pipe 2 and sub-pipe 3.3 (1220 and 1260)), sub-graph 1320 contains section 2, 4 and 5 (1120, 1140, and 1150) as well as pipe 1 and sub-pipes 3.0 to 3.2 (1210, 1230, 1240, and 1250), and sub-graph 1330 contains sections 6 and 7 (1160 and 1170) as well as pipes 4 to 6 (1270, 1280, and 1290).

### Operation Space

When executing progressions of operations, for example structured in a directed graph, each section could represent a different operation. It is not necessary for each operation to be of the same type or nature. This is particularly the case where the graph of operations is used to represent the processing of a neural network. The machine learning software ecosystem allows for a diverse structure of neural networks that are applicable to many different problem spaces, and as such there is a very large possible set of operators from which a neural network can be composed.

It is desirable to define a set of pre-determined low-level operations from which a broad range of possible higher-level operations that correspond with various machine learning tool sets can be built. One example of such a low-level set of operations, is the Tensor Operator Set Architecture (TOSA). The Tensor Operator Set Architecture (TOSA) provides a set of whole-tensor operations commonly employed by Deep Neural Networks. The intent is to enable a variety of implementations running on a diverse range of processors, with the results at the TOSA level consistent across those implementations. Applications or frameworks which target TOSA can therefore be deployed on a wide range of different processors, including single-instruction multiple-data (SIMD) CPUs, graphics processing units (GPUs) and custom hardware such as neural processing units/tensor processing units (NPUs/TPUs), with defined accuracy and compatibility constraints. Most operators from the common ML frameworks (TensorFlow, PyTorch, etc.) should be expressible in TOSA.

Many of the operations in a defined operation set (such as TOSA) can be represented as a loop of scalar operations. For example, consider a 2D convolution operation which can be expressed as a multi-dimensional loop of scalar operations. These may need to be executed on 2D input data having dimensions input X (IX) and input Y (IY):
(input) Input channel (IC)—a dimension representing the input channels upon which the operation is to be performed (in the example of images this may be three channels each representing one of red, green, and blue input channels)
(input) Kernel dimension X (KX)—a first dimension X of a 2D kernel;
(input) Kernel dimension Y (KY)—a second dimension Y of a 2D kernel;
(output) Output X (OX)—a first dimension of the output feature map for the convolution operation;
(output) Output Y (OY)—a second dimension of the output feature map for the convolution operation;
(output) Batch (N)—a batch dimension of the operation, where the operation is to be batched;
(output) Output channel (OC)—a dimension representing the output channels to be produced for the 2D convolution operation.

In one proposed ordering, KY/KX can be considered the inner-most dimensions and OC is the outer-most dimension.

For the 2D convolution operation example above, it is possible to express the operation to be performed as a “nested for-loop” of scalar operations as is illustrated in the pseudo-code set out below. In practice, when executing this operation, it is necessary for a processor to execute the operation across each of these dimensions by performing a multiple-accumulate operation (MAC), the result of which is then written into an accumulator (e.g. an accumulator buffer in hardware). Having operated through all of these dimensions, the 2D convolution is completed and the contents of the accumulator therefore represents the result of the 2D convolution operation across the entire dimensionality of operation.

```
for(output channel)
  for(batch N)
    for(output Y)
      for(output X)
        for(input channel)
          for(kernel Y)
            for(kernel X)
              MAC
              write accumulator
```

The seven dimensions of the convolution operation can collectively be used to define the ‘operation space’ in which the 2D convolution operation is to be performed. More specifically, the sizes of each dimension can be used to define an effective “bounding box” defining the size, the number of elements in each dimension, of the operation space upon which the operation is to be performed. To illustrate this in more detail, consider an example where a 3×3 (i.e. KX=3; KY=3) convolution operation having padding is to be performed on input data having dimension IX=15; IY=15; N=1; and IC=32. This operation results in the following minimum and maximum index values representing the upper and lower bounds inclusive (i.e. the size) of the dimensionality of the convolution operation as shown in Table 1:

TABLE 1

| | OC | N | OY | OX | IC | KY | KX |
|---|---|---|---|---|---|---|---|
| Min | 0 | 0 | 0 | 0 | 0 | 0 | 0 |
| Max | 63 | 0 | 14 | 14 | 31 | 2 | 2 |

The output of the 2D convolution operation would have dimensions N=1; OY=15; OX=15; OC=64. These values represent the size of the output of the 2D convolution operation but they do not alone wholly represent the size of the operation required to generate that output. To wholly represent the operation space of the operation, all of the dimensions of the operation are required as shown in the above table. A shorthand representation for the dimensions of the 2D convolution operation is [OC N OY OX IC KY KX] and in this specific example can be presented as the minimum and maximum index values as illustrated in the example above i.e. [64 1 15 15 32 3 3].

Operations such as the 2D convolution operation described above can be separated into operation blocks, each operation block representing a subset of an operation in which each dimension of the operation block covers a subset of the full range of the corresponding dimension in the operation. For example, the 2D convolution described above can be separated into multiple operation blocks by breaking up the operation in the OY, OX, and IC dimensions. With an operation separated into operation blocks, each operation block remains at the same dimension as prior to the separation. For example, breaking up the operation in the OY dimension results in multiple operation blocks in the OY dimension. Breaking the operation into blocks involves separating the operation space of the operation into multiple blocks which each individually represent a portion of the operation but collectively represent the operation space. This block generation involves separating the operation space into blocks representing a non-overlapping subset of the dimensions in the operation space which wholly cover the operation space dimensions (e.g. the set of nested for-loops shown above). In an example where the operation is to be separated into a number of blocks, the operation space is broken down into blocks based upon a predetermined block size which defines for each dimension of the operation a fixed size. This fixed size block may be referred to herein as a block quantum.

### Hardware Implementation

As described above, a data structure in the form of a directed graph may comprise plural sequenced operations that are connected to one another for execution in a progression. Described below is an example hardware arrangement for executing linked operations for at least a portion of a directed graph as illustrated in FIG. 6a.

FIG. 6b shows schematically an example of a data processing system 600 including a processor 630 which may act as a co-processor or hardware accelerator unit for a host processing unit 610. It will be appreciated that the types of hardware accelerator which the processor 630 may provide dedicated circuitry for is not limited to that of Neural Processing Units (NPUs) or Graphics Processing Units (GPUs) but may be dedicated circuitry for any type of hardware accelerator. GPUs may be well-suited for performing certain types of arithmetic operations such as neural processing operations, as these operations are generally similar to the arithmetic operations that may be required when performing graphics processing work (but on different data formats or structures). Furthermore, GPUs typically support high levels of concurrent processing (e.g. supporting large numbers of execution threads), and are optimized for data-plane (rather than control plane) processing, all of which means that GPUs may be well-suited for performing other types of operations.

That is, rather than using entirely separate hardware accelerators, such as a machine learning processing unit that is independent of the graphics processor, such as an NPU, or only being able to perform machine learning processing operations entirely using the hardware of the GPU, dedicated circuitry may be incorporated into the GPU itself.

This means that the hardware accelerator circuitry incorporated into the GPU is operable to utilize some of the GPU's existing resources (e.g. such that at least some functional units and resources of the GPU can effectively be shared between the different hardware accelerator circuitry, for instance), whilst still allowing an improved (more optimized) performance compared to performing all the processing with general purpose execution.

As such, the processor 630 may be a GPU that is adapted to comprise a number of dedicated hardware resources, such as those which will be described below.

In some examples, this can be particularly beneficial when performing machine learning tasks that themselves relate to graphics processing work, as in that case all of the associated processing can be (and preferably is) performed locally to the graphics processor, thus improving data locality, and (e.g.) reducing the need for external communication along the interconnect with other hardware units (e.g. an NPU). In that case, at least some of the machine learning processing work can be offloaded to the machine learning processing circuit, thereby freeing the execution unit to perform actual graphics processing operations, as desired.

In other words, in some examples, providing a machine learning processing circuit within the graphics processor means that the machine learning processing circuit may then be operable to perform at least some machine learning processing operations whilst the other functional units of the graphics processor are simultaneously performing graphics processing operations. In the situation where the machine learning processing relates to part of an overall graphics processing task this can therefore improve overall efficiency (in terms of energy efficiency, throughput, etc.) for the overall graphics processing task.

In FIG. 6b, the processor 630 is arranged to receive task data 620 from a host processor 610, such as a central processing unit (CPU). The task data comprises at least one command in a given sequence, each command to be executed, and each command may be decomposed into a number of tasks, such as tasks discussed in this disclosure. These tasks may be self-contained operations, such as a given machine learning operation or a graphics processing operation. It will be appreciated that there may be other types of tasks depending on the command.

The task data 620 is sent by the host processor 610 and is received by a command processing unit 640 which is arranged to schedule the commands within the task data 620 in accordance with their sequence. The command processing unit 640 is arranged to schedule the commands and decompose each command in the task data 620 into at least one task. Once the command processing unit 640 has scheduled the commands in the task data 620, and generated a plurality of tasks for the commands, the command processing unit 640 issues each of the plurality of tasks to at least one compute unit 650a, 650b each of which are configured to process at least one of the plurality of tasks.

The processor 630 comprises a plurality of compute units 650a, 650b. Each compute unit 650a, 650b, may be a shader core of a GPU specifically configured to undertake a number of different types of operations, however it will be appreciated that other types of specifically configured processor may be used, such as a general-purpose processor configured with individual compute units, such as compute units 650a, 650b. Each compute unit 650a, 650b comprises a number of components, and at least a first processing module 652a, 652b for executing tasks of a first task type, and a second processing module 654a, 654b for executing tasks of a second task type, different from the first task type. In some examples, the first processing module 652a, 652b may be a processing module for processing neural processing operations, such as those which would normally be undertaken by a separate NPU. In these cases, the first processing module 652a, 652b is for example a neural engine. Similarly, the second processing module 654a, 654b may be a processing module for processing graphics processing operations forming a set of pre-defined graphics processing operations which enables the implementation of a graphics processing pipeline, which may be referred to as a graphics processor. For example, such graphics processing operations include a graphics compute shader task, a vertex shader task, a fragment shader tasks, a tessellation shader task, and a geometry shader task. These graphics processing operations may all form part of a set of pre-defined operations as defined by an application programming interface, API. Examples of such APIs include Vulkan, Direct3D and Metal. Such tasks would normally be undertaken by a separate/external GPU. It will be appreciated that any number of other graphics processing operations may be capable of being processed by the second processing module.

As such, the command processing unit 640 issues tasks of a first task type to the first processing module 652a, 652b of a given compute unit 650a, 650b, and tasks of a second task type to the second processing module 654a, 354b of a given compute unit 650a, 650b. The command processing unit 640 would issue machine learning/neural processing tasks to the first processing module 652a, 652b of a given compute unit 650a, 650b where the first processing module 652a, 652b is optimized to process neural network processing tasks, for example by comprising an efficient means of handling a large number of multiply-accumulate operations. Similarly, the command processing unit 640 would issue graphics processing tasks to the second processing module 654a, 654b of a given compute unit 650a, 650b where the second processing module 652a, 654a is optimized to process such graphics processing tasks. In some examples, the first and second tasks may both be neural processing tasks issued to a first processing module 652a, 652b, which is a neural engine. Such a neural processing task may involve the processing of a tensor, e.g. representing a feature map, with weights associated with a layer of a neural network.

In addition to comprising a first processing module 652a, 652b and a second processing module 654a, 654b, each compute unit 650a, 650b also comprises a memory in the form of a local cache 656a, 656b for use by the respective processing module 652a, 652b, 654a, 654b during the processing of tasks. Examples of such a local cache 656a, 656b is a L1 cache. The local cache 656a, 656b may, for example, a synchronous dynamic random-access memory (SDRAM). For example, the local cache 656a, 656b may comprise a double data rate synchronous dynamic random-access memory (DDR-SDRAM). It will be appreciated that the local cache 656a, 656b may comprise other types of memory.

The local cache 656a, 656b is used for storing data relating to the tasks which are being processed on a given compute unit 650a, 650b by the first processing module 652a, 652b and second processing module 654a, 654b. It may also be accessed by other processing modules (not shown) forming part of the compute unit 650a, 650b the local cache 656a, 656b is associated with. However, in some examples, it may be necessary to provide access to data associated with a given task executing on a processing module of a given compute unit 650a, 650b to a task being executed on a processing module of another compute unit (not shown) of the processor 630. In such examples, the processor 630 may also comprise storage 660, for example a cache, such as an L2 cache, for providing access to data for the processing of tasks being executed on different compute units 650a, 650b.

By providing a local cache 656a, 656b tasks which have been issued to the same compute unit 650a, 650b may access data stored in the local cache 656a, 656b, regardless of whether they form part of the same command in the task data 620. The command processing unit 640 is responsible for allocating tasks of commands to given compute units 650a, 650b such that they can most efficiently use the available resources, such as the local cache 656a, 656b, thus reducing the number of read/write transactions required to memory external to the compute units 650a, 650b, such as the storage 660 (L2 cache) or higher-level memories. One such example, is that a task of one command issued to a first processing module 652a of a given compute unit 650a, may store its output in the local cache 656a such that it is accessible by a second task of a different (or the same) command issued to a given processing module 652a, 654a of the same compute unit 650a.

One or more of the command processing unit 640, the compute units 650a, 650b, and the storage 660 may be interconnected using a bus. This allows data to be transferred between the various components. The bus may be or include any suitable interface or bus. For example, an ARM® Advanced Microcontroller Bus Architecture (AMBAR) interface, such as the Advanced extensible Interface (AXI), may be used.

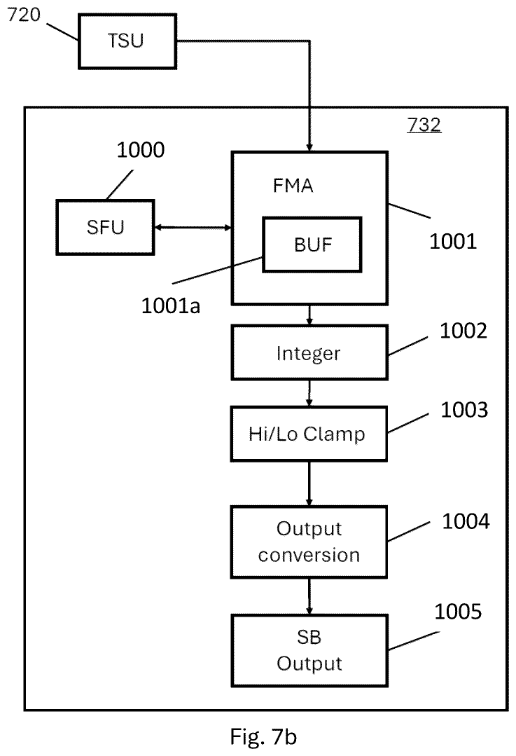

FIG. 7a is a schematic diagram of a neural engine 700, which in this example is used as a first processing module 652a, 652b in a data processing system 600 in accordance with FIG. 6b. The neural engine 700 includes a command and control module 710. The command and control module 710 receives tasks from the command processing unit 640 (shown in FIG. 6b), and also acts as an interface to storage external to the neural engine 700 (such as a local cache 656a, 656b and/or a L2 cache 660) which is arranged to store data to be processed by the neural engine 700 such as data representing a tensor, or data representing a stripe of a tensor. In the context of the present disclosure, a stripe is a subset of a tensor in which each dimension of the stripe covers a subset of the full range of the corresponding dimension in the tensor. The external storage may additionally store other data to configure the neural engine 700 to perform particular processing and/or data to be used by the neural engine 700 to implement the processing such as neural network weights.

The command and control module 710 interfaces to a handling unit 720, which is for example a traversal synchronization unit (TSU). In this example, each task corresponds to a stripe of a tensor which is to be operated upon in accordance with a sequence of operations according to at least a portion (e.g. a sub-graph) of the directed graph representation of the neural network. The tensor for example represents a feature map for processing using the neural network. A neural network typically includes a sequence of layers of processing, with an output from each layer being used as an input to the next layer. Each layer for example processes an input feature map by operating upon the input feature map to generate an output feature map, which is used as the input feature map for the next layer. The term “feature map” is used generically herein to refer to either an input feature map or an output feature map. The processing performed by a given layer may be taken to correspond to an operation.

In this example, the handling unit 720 splits data representing a stripe of a feature map into a plurality of blocks of data, each of which represents a respective part of the feature map. The handling unit 720 also obtains, from storage external to the neural engine 700 such as the L2 cache 660, task data defining operations selected from an operation set comprising a plurality of operations. In this example, the operations are structured as a progression of operations representing a sequence of layers of the neural network. The operations are representable as a directed graph of operations, e.g. as described with reference to FIG. 6a, comprising operations connected by connections corresponding to respective logical storage locations, such that a connection associated with an output of an operation of the operations corresponds to a logical storage locations. A block of data is allocated as an input to one of the operations by the handling unit 720.

The handling unit 720 coordinates the interaction of internal components of the neural engine 700, which include a weight fetch unit 722, an input reader 724, an output writer 726, a direct memory access (DMA) unit 728, a dot product unit (DPU) array 730, a vector engine 732, a transform unit 734, an accumulator buffer 736, and a shared storage 738, for processing of blocks of data. The data dependencies across the functional units are tracked by the handling unit 720. Processing is initiated by the handling unit 720 in a functional unit if all input blocks are available and space is available in the shared storage 738 of the neural engine 700. The shared storage 738 may be considered to be a shared buffer, in that various functional units of the neural engine 700 share access to the shared storage 738.

In the context of a directed graph representing the operations to be performed, each of the internal components that operates upon data can be considered to be one of two types of component. The first type of component is an execution unit (and is identified within the neural engine 700 as such) that maps to a section that performs a specific instance of an operation within the directed graph. The execution unit may be implemented using execution circuitry and may thus be referred to interchangeably as execution circuitry. For example, the weight fetch unit 722, input reader 724, output writer 726, dot product unit array 730, vector engine 732, transform unit 734 each are configured to perform one or more pre-determined and fixed operations upon data that it receives. Each of these sections can be uniquely identified with an identifier and each execution unit can also be uniquely identified.

Similarly, all physical storage elements within the neural engine (and in some instances portions of those physical storage elements) can be considered to be uniquely identified within the neural engine. The handling unit 720 is configured to allocate storage elements to respective connections in the directed graph, which can correspond to pipes as explained above. For example, portions of the accumulator buffer 736 and/or portions of the shared storage 738 can each be regarded as a storage element that can act to store data for a pipe or a sub-pipe within the directed graph, as allocated by the handling unit 720. A pipe or a sub-pipe can act as a connection between sections (as executed by execution units) to enable a sequence of operations as defined in the directed graph to be linked together within the neural engine 700. Put another way, the logical dataflow of the directed graph can be mapped to the physical arrangement of execution units and storage elements within the neural engine 700. Under the control of the handling unit 720, execution can be scheduled on the execution units and data can be passed between the execution units via the storage elements in accordance with the mapping, such that the linked operations of a graph can be executed without needing to write data memory external to the neural engine 700 between executions. The handling unit 720 is configured to control and dispatch work representing performing an operation of the graph on at least a portion of the data provided by a pipe or a sub-pipe.

The weight fetch unit 722 fetches weights associated with the neural network from external storage and stores the weights in the shared storage 738. The input reader 724 reads data to be processed by the neural engine 700 from external storage, such as a block of data representing part of a tensor. The output writer 726 writes data obtained after processing by the neural engine 700 to external storage. The weight fetch unit 722, input reader 724 and output writer 726 interface with the external storage (which is for example the local cache 656a, 656b, which may be a L1 cache such as a load/store cache) via the DMA unit 728.

Data is processed by the DPU array 730, vector engine 732 and transform unit 734 to generate output data corresponding to an operation in the directed graph. The result of each operation is stored in a specific pipe or sub-pipe within the neural engine 700. The DPU array 730 is arranged to perform one or more operations associated with a dot product operation between two operands, such as between an array of weights and a corresponding block of data (e.g. representing part of a tensor).

The vector engine 732 is arranged to perform elementwise operations, for example to apply scale parameters to scale an output of a dot product calculated by the DPU array 730. In examples herein, the execution unit configured to execute the operation using the value data selected based on the value selection data is the vector engine 732. The operation is for example an elementwise operation comprising elementwise processing of the value data with input data, such as a block of an input tensor to be processed. For example if the operation to be performed by the vector engine 732 is an add operation and the value data represents a constant value, the vector engine 732 is configured to add the constant value to each element of a block to be processed, e.g. a block of a tensor. Such an operation can be used to add a constant bias or offset to the block.

Data generated during the course of the processing performed by the DPU array 730 and the vector engine 732 may be transmitted for temporary storage in the accumulator buffer 736 from where it may be retrieved by either the DPU array 730 or the vector engine 732 (or another different execution unit) for further processing as desired.

The transform unit 734 is arranged to perform in-block transforms such as dimension broadcasts or axis swaps. The transform unit 734 obtains data (e.g. after processing by the DPU array 730 and/or vector engine 732) from a pipe or a sub-pipe, for example mapped to at least a portion of the shared storage 738 by the handling unit 720. The transform unit 734 writes transformed data back to the shared storage 738.

To make efficient use of the shared storage 738 available within the neural engine 700, the handling unit 720 determines an available portion of the shared storage 738, which is available during execution of part of a first task (e.g. during processing of a block of data associated with the first task by the DPU array 730, vector engine 732 and/or transform unit 734). The handling unit 720 determines a mapping between at least one logical address associated with data generated during execution of a second task (e.g. by processing of a block of data associated with the second task by the DPU array 730, vector engine 732 and/or transform unit 734) and at least one physical address of the shared storage 738 corresponding to the available portion. The logical address is for example a global address in a global coordinate system. Hence, by altering the physical address corresponding to a given logical address, the handling unit 720 can effectively control usage of the shared storage 738 without requiring a change in software defining the operation to be performed, as the same logical address can still be used to refer to a given element of the tensor to be processed. The handling unit 720 identifies the at least one physical address corresponding to the at least one logical address, based on the mapping, so that data associated with the logical address is stored in the available portion. The handling unit 720 can perform the mapping process according to any of the examples herein.

In an analogous manner, the handling unit 720 can determine a mapping between logical storage locations (e.g. corresponding to respective logical addresses) corresponding to respective connections within the directed graph and sets of storage elements (e.g. corresponding to sets of physical addresses within storage of the neural engine 700, such as within the accumulator buffer 736 and/or the shared storage 738). In this way, the handling unit 720 can for example dynamically allocate first and second sets of storage elements to correspond to first and second logical storage locations associated with first and second operations (e.g. first and second sections) of the directed graph.

The handling unit 720 can for example allocate respective physical storage locations (e.g. corresponding to respective storage elements of the storage of the neural engine 700, such as respective buffers of the accumulator buffer 736 and/or the shared storage 738) for storing respective blocks generated by an operation of the directed graph, such as by a production operation. In allocating the physical storage locations, the handling unit 720 may map logical storage locations (e.g. corresponding to respective logical addresses) corresponding to respective connections within the directed graph to respective sets of storage elements. The mapping may be performed dynamically by the handling unit 720, to utilize the storage of the neural engine 700 more efficiently.

It will be appreciated that in a graph of operations there does not need to be only a single instance of a particular type of operation. For example, multiple instances of a convolution operation could be present in a graph of operations. In the above example hardware arrangement only a single convolution engine may be present. Therefore, it will be appreciated that there does not need to be a direct 1:1 mapping between operations in the graph (sections) and execution units, and similarly no direct 1:1 mapping between pipes and storage elements and/or between sub-pipes and storage elements. In particular, a single execution unit may be configured at different instances in time to execute different instances of a convolution operation (e.g. first and second sections). Similarly, the input reader may be required to read data as part of different sections in the graph. The same can be said for storage elements and pipes and/or sub-pipes.

All storage in the neural engine 700 may be mapped to corresponding pipes and/or sub-pipes, including look-up tables, accumulators, etc., as discussed further below. The width and height of pipes and/or sub-pipes can be programmable, resulting a highly configurable mapping between pipes, sub-pipes and storage elements within the neural engine 700. For example, the handling unit 720 may map a source logical storage location to a source physical storage location of the storage and a destination logical storage location to a destination physical storage location of the storage, with at least one of the source physical storage location and the destination physical storage location corresponding to a connection between an operation to be executed in executing the task described by the task data and a further operation in the directed graph to which the operation is connected. In these examples, the invocation data dispatched by the handling unit 720 to an execution unit may describe at least one of the source or destination physical storage locations, so as to instruct the execution unit to read and/or write data at one of these locations in executing the operation.

Ordering of execution of the sections is implied by dependencies on inputs. A memory load operation has no data dependencies (unless it is a gather operation), so is implicitly early in the graph. The consumer of the pipe (or sub-pipe) that the memory read produces is implicitly after the memory read. A memory store operation is near the end of the graph, as it produces no pipes or sub-pipes for other operations to consume. The sequence of execution of a progression of operations is therefore handled by the handling unit 720.

### Vector Engine and Forwarding Pipes

FIG. 7b shows more detail of an execution unit in the form of the vector engine 732 of a neural engine 652a. As explained above, the vector engine 732 receives task data from the handling unit (TSU) 720. A first portion of the vector engine 732 comprises a Floating Point Multiply/Add/Accumulate unit (FMA) 1001 and a special function unit (SFU) 1000. The FMA 101 provides functionality for floating point multiply, add, and accumulate operations. In some implementations, these may be one of the following operations:

$$A * B$$

$$A * B + ACC$$

$$A + B$$

$$A + AC C$$

where ACC is the value stored in an accumulator.

The accumulator (not shown) may make use of a storage in the vector engine 732 that may be formed of a number, n, of 32-bit storage locations.

The SFU 1000 is a unit configured to perform polynomial approximation of transcendental functions. In some implementations, the SFU is configured to perform a third-order polynomial approximation using look-up tables to identify relevant coefficients. The SFU may approximate functions such as logarithm, sigmoid, tanh, reciprocal square root, etc. that are non-linear and cannot easily be calculated directly. In some implementations, the SFU may calculate values for functions other than transcendental functions.

The vector engine 732 further comprises an integer processing unit 1002 configured to perform processes on integer values including integer multiply/add/accumulate, integer bit shifting, logical operations (AND, OR, XOR, NOT), comparison and division.

A Hi/Lo Clamp unit 1003 within the vector engine 732 is configured to reduce numbers to a required output format and is used for calculating values associated with the ReLU function.

An output conversion unit 1004 is provided within the vector engine 732 that is configured to convert tensors between numerical formats. For example, the output conversion unit 1004 may be configured to implement the casts specified in the TOSA specification. Examples include, but are not limited to, conversion from 16-bit floating point to 16-bit integer, conversion from 16-bit floating point to 8-bit floating point, conversion from 32-bit integer to 16-bit floating point etc. The output conversion unit 1004 may also support stochastic rounding. In some implementations, some of the conversions, such as 16-bit floating point to 16-bit integer may be performed in other units, such as integer processing unit 1002.

The shared buffer output unit 1005 is configured to output the result of processing by the vector engine 732 and transfer the result to the shared storage 738. It is noted that while FIG. 7b shows single direction arrows within the vector engine 732, the vector engine may be configured to transfer data between the components shown in FIG. 7b in any order as appropriate depending on the configured functionality within the vector engine.

In a naïve implementation, the vector engine 732 may receive a sequence of a sequence of invocations each relating to one of a sequence of different operations. These operations will have been scheduled by the handling unit 720 and source and destination pipes would be allocated in the shared storage 738. However, where a sequence of operations is to be performed by the vector engine 732 on data consecutively this approach leads to repeated writes to and reads from the shared storage 738 which consumes power and uses unnecessary storage as the storage in the shared storage 738 for each source and destination pipe needs to be allocated by the handling unit 720.

To improve power consumption and improve storage utilization in the shared storage 738 the following approaches may be implemented. A first approach will be referred to as barrel scheduling and second approach will be referred to as local buffering. According to each approach, the control originates with the compiler (e.g. graph compiler) that generates the task data that is sent to the processor 630. It is noted that compilation of instructions to be performed by the processor 630 is performed before the processor executes the task and may be performed a considerable time (i.e. not in real time with) before the task is processed by the processor.

According to some implementations, the compiler is configured to identify a plurality of sequential operations that are to be performed by a vector engine on data. The compiler configures the NED with “forwarding pipe” configuration data to identify the plurality of sequential operations that should be performed by the vector engine 732.

Upon receipt of the task data generated by the compiler, the handling unit 720 parses the task data and identifies the plurality of operations configured with the “forwarding pipe” configuration data. The handling unit 720 generates a single invocation that includes the plurality of operations that occur in sequence and sends that group of operations in the invocation data to the vector engine 732.

When executing the first approach, referred to above as barrel scheduling, the vector engine 732 reads data from the shared storage 738 and processes the sequence of operations so that as data is processed by the vector engine 732 the data is recycled without the need to write the output data to a storage, such as the shared storage 738. According to the second approach, referred to as the local buffering approach, instead of immediately recycling the data, the data is stored on a storage local to the vector engine, such as buffer 1001a shown in FIG. 7b, rather than storing the data in the shared storage 738, which is not local to the vector engine 732. The local storage, e.g. buffer 1001a, will typically be of smaller capacity than the shared storage 738, but will be able to store a small amount of data to make the processing by the vector engine 732 more efficient.

In more general terms, the local storage is a storage to which the vector engine 732, or more generally an execution unit, has faster or more energy efficient access to compared to the non-local storage, such as the shared buffer 738. The local storage may be included in the execution unit as in the described embodiment shown in FIG. 7b. The local storage may be accessible by the execution unit but not by other execution units. The non-local storage may be a shared storage that is accessible by a plurality of execution units.

In some examples herein, such as those in which the approaches described above of barrel scheduling or local buffering are performed, the task data comprises further value selection data for use in selecting further value data representing a further value for executing a further operation, which is for example a further operation to be grouped with the operation for which the value data is to be selected based on the value selection data. The further operation comprises processing further input data from a further input logical storage location of the logical storage locations with the further value data. In these examples, the handling unit 720 uses the further value selection data to select the further value data. The further operation may be the same type of operation as the operation, but performed on different input data. For example, both the operation and the further operation may be addition operations, comprising an elementwise addition of a broadcast value (represented by value data and further value data, respectively) to input data and further input data, respectively. The value data and/or the further value data may be encoded in different respective fields of the task data or at least one of the value data and/or the further value data may be obtained separately from the task data, e.g. from respective portions of at least one boundary register accessible to the handling unit 720. For example, the value data and the further value data may be obtained from high and low portions of a particular boundary register, respectively (or vice versa), or from respective portions of different boundary registers to each other. The value data and the further value data may each be derived value data, derived for different respective blocks to be processed (which blocks may be stored in different respective input logical storage locations of the storage). This facilitates the grouping of operations, which may reduce power consumption.

The invocation data sent to the execution unit (e.g. the vector engine 732) is further based on the further value data so as to cause the execution unit to execute the further operation (in addition to the operation). For example, the handling unit 720 may generate a single invocation for a group of operations including the operation and the further operation and send the single invocation to the vector engine 732 for execution. The single invocation includes respective value data (or a pointer to the value data) for each of the operations in the group. Accordingly, there may be a plurality of pieces of value data, each for a different respective operation of the group of operations.

### System for Allocating Handling Data

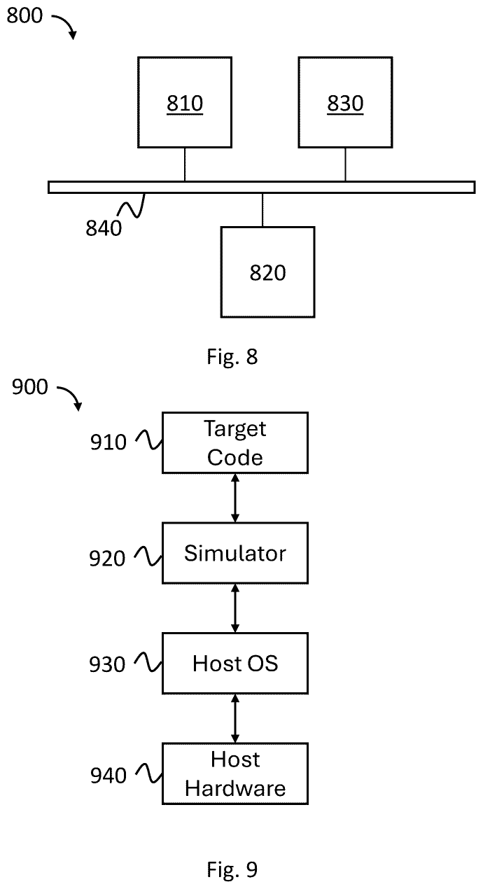

FIG. 8 shows schematically a system 800 for allocating handling data, and in some examples generating a plurality of blocks of input data for processing.

The system 800 comprises host processor 810 such as a central processing unit, or any other type of general processing unit. The host processor 810 issues task data comprising a plurality of commands, each having a plurality of tasks associated therewith.

The system 800 also comprises a processor 830, which may be similar to or the same as the processor 630 of FIG. 6b and may comprise at least some of the components of and/or be configured to perform the methods described above. The processor 830 comprises at least a plurality of compute units 650a, 650b and a command processing unit 640. Each compute unit may comprise a plurality of processing modules each configured to perform at least one type of operation. The system 800 may also include at least one further processor (not shown), which may be the same as the processor 830. The processor 830, and the host processor 810 may be combined as a System on Chip (SoC) or onto multiple SoCs to form one or more application processors.

The system 800 also comprises memory 820 for storing data generated by the tasks externally from the processor 830, such that other tasks operating on other processors may readily access the data. However, it will be appreciated that the external memory usage will be used sparingly, due to the allocation of tasks as described above, such that tasks requiring the use of data generated by other tasks, or requiring the same data as other tasks, will be allocated to the same compute unit 650a, 650b of a processor 830 so as to maximize the usage of the local cache 656a, 656b.

In some examples, the system 800 may comprise a memory controller (not shown), which may be a dynamic memory controller (DMC). The memory controller is coupled to the memory 820. The memory controller is configured to manage the flow of data going to and from the memory. The memory may comprise a main memory, otherwise referred to as a ‘primary memory’. The memory may be an external memory, in that the memory is external to the system 800. For example, the memory 820 may comprise ‘off-chip’ memory. The memory may have a greater storage capacity than local caches of the processor 830 and/or the host processor 810. In some examples, the memory 820 is comprised in the system 800. For example, the memory 820 may comprise ‘on-chip’ memory. The memory 820 may, for example, comprise a magnetic or optical disk and disk drive or a solid-state drive (SSD). In some examples, the memory 820 comprises a synchronous dynamic random-access memory (SDRAM). For example, the memory 820 may comprise a double data rate synchronous dynamic random-access memory (DDR-SDRAM).

One or more of the host processor 810, the processor 830, and the memory 820 may be interconnected using a system bus 840. This allows data to be transferred between the various components. The system bus 840 may be or include any suitable interface or bus. For example, an ARM® Advanced Microcontroller Bus Architecture (AMBAR) interface, such as the Advanced extensible Interface (AXI), may be used.

### Neural Engine Program Descriptor (NED)

As explained above, the neural engine 700 receives tasks from the command processing unit 640 to execute operations from the directed graph. The neural engine 700 is configured to execute operations selected from a base set of operations defining an operator set. One example of such an operator set is the Tensor Operator Set Architecture (TOSA) base inference profile, which defines a set of operations that can collectively be used to define the operations of a wide range of neural network operations. One exception to the TOSA operator set is control flow operations that may be implemented by way of task data processed by the command processing unit 640. It will be appreciated that there may be multiple neural engines with the processor 630 and thus multiple tasks can be issued concurrently to different neural engines.

In an example implementation, a task issued by the command processing unit 640 for execution by the neural engine 700 is described by task data which in this example is embodied by a neural engine program descriptor (NED), which is a data structure stored in memory and retrieved by the neural engine when executing the task issued by the command processing unit. The NED describes at least a portion of a complete graph of operations (sections) to be performed when executing the graph of operations (e.g. representing a neural network). As discussed above, sections are mapped to various hardware execution units within the neural engine 700 and essentially represent instantiations of a particular operator at a position within the graph. In one example, these sections are described by specific ‘elements’ that collectively define the operations forming part of the NED. Furthermore, the NED has an unordered list of pipes and/or sub-pipes (graph vertices) and an unordered list of sections/operations (graph nodes). Each operation specifies its input and output giving rise to adjacency of operation in the directed graph to which a particular operation is connected. An example NED comprises a NED structure comprising a header, the elements each corresponding to a section in the graph. The NED describes the various requirements of ordering, number and relationship of these sections and pipes and/or sub-pipes. In one implementation, each of the execution units and each storage element (or portion of a storage element) of the neural engine 700 has a sub-descriptor definition which defines how that execution unit/storage element can be configured for use in implementing a specific section, pipe or sub-pipe in the graph. An example of the hardware units and their corresponding elements is set out below:
Weight Fetch (WF): NEDWeightFetchElement
Input Reader (IR): NEDInputReaderElement
Output Writer (OW): NEDOutputWriterElement
Convolution Engine (CE): NEDConvolutionEngineElement
Transform Unit (TU): NEDTransformUnitElement
Vector Engine (VE): NEDVectorEngineElement

The NED therefore may specify the execution unit or in other words specify a compatible execution unit for each operation. In embodiments there may be more than one execution unit of a given type such as InputReader may have two command queues which can operate concurrently. A NED may specify which of the queues is assigned so that there remains a 1:1 relationship between what the NED specifies and the physical hardware to which it points.

The sub-descriptor definition for a particular execution unit, as specified by the NED, may include a field for the value selection data. In an example, the value selection data corresponds to a value selection field of the NEDVectorEngineElement sub-descriptor definition for the VE. The value selection data of the value selection field is used to indicate the value data to be selected for executing an operation using the VE. In this example, the NEDVectorEngineElement sub-descriptor definition also includes a value field for storing data that may be selected as the value data depending on a state of the value selection field. If the value selection field has a first predetermined state (e.g. a binary value of 0), this indicates that the value data from the value field of the NEDVectorEngineElement sub-descriptor definition is to be selected to execute the operation using the VE. However, if the value selection field has a second predetermined state (e.g. a binary value of 1), this indicates that the value data is to be supplied to the VE externally to the NED, e.g. using a high or low portion of a boundary register of a set of boundary registers for storing data defining a block to be operated on in executing the operation. The value data stored in the boundary register is for example derived value data, which is derived by processing at least a portion of the task data. If the value data stored in the boundary register (e.g. derived value data) is to be selected as the value data, the value data stored in the value field of the NEDVectorEngineElement may be unused in executing the operation. The VE is for example used to execute elementwise operations, allowing the value data selected in accordance with the value selection data to be selected flexibly and efficiently for performing an elementwise operation, e.g. involving broadcasting of the value data.

The dataflow and dependencies of the task's graph is described by pipes and/or sub-pipes. Pipes and/or sub-pipes are used to represent data storage elements within the neural engine 700 and describe the relationship between sections (operations) in a producer-consumer relationship: the output destination pipe or sub-pipe (e.g. a pipe or sub-pipe number) and each input source pipe or sub-pipe (e.g. a pipe or sub-pipe number) for every section is defined in the NED elements of the NED. Pipes and sub-pipes each have only a single producer but may have multiple consumers. A pipe and/or a sub-pipe may be mapped to one of several different physical storage locations (e.g. storage units in the neural engine 700), but not all physical storage locations may be suitable for the different section operations. It will be appreciated that, in some arrangements, a pipe may be mapped to only a portion of a storage unit, which may include at least one storage element. For example, a physical buffer (or a set of physical buffers, which may be or form part of a memory bank) may be considered to be a storage unit, and a physical address (or a set of physical addresses) corresponding to or within a physical buffer may be considered to be a storage element. For example, a storage unit may correspond to a set of physical buffers and a storage element may be a physical buffer of the set of physical buffers, the physical buffer comprising a set of physical addresses. In such cases, a pipe and/or a sub-pipe can describe double-buffering (for example) behavior between its producer and consumers. The output data generated by a section and stored in a pipe or a sub-pipe is referred to equivalently as both a block (of data) and a (virtual) buffer, with a block of data occupying one physical buffer location. Irrespective of location, pipes and/or sub-pipes may be non-coherent with a wider memory system associated with the neural engine 700 and with processor 630, and data is stored out using the Output Writer element of the neural engine 700.

In some arrangements the NED may be configured such that the same pipe is used for multiple inputs, where any relevant usage constraints (such as format or location) are satisfied. For example, an element-wise multiply might have the same pipe for the two input operands in order to square the input. In examples, though, the NED may be configured such that each sub-pipe has a single producer.

In some embodiments, sections such as InputReader and WeightFetcher have no input pipes and/or sub-pipes and instead their data comes from external memory, such as an external cache or DRAM. By contrast, some sections, such as OutputWriter have no output pipes or sub-pipes. In this case, their data is written to external memory.

For a section to run, it must have all the appropriate buffers available for its input source pipes and/or sub-pipes. A section may produce a new buffer in its output destination pipe or sub-pipe and so there must be space available in the pipe or sub-pipe for this new buffer. The neural engine 700 is responsible for tracking all of these dependencies.

The NED is split into multiple data structures that may appear contiguously in memory to be read by the neural engine 700. In this example implementation, the NED header defines the dimensions of the operation space of the operations to be performed. Specifically, the NED header defines the total size of the NED (e.g. number of bytes to be used to represent the NED) as well as a count of the number of section and pipes that are present in the graph.

For each section and pipe in the graph, a count of a corresponding mapped sub-descriptor element types is represented in the NED header. For instance, where the graph (or sub-graph) contains a number of sections, each of those sections is to be executed on a particular compatible execution unit of the neural engine 700. For each section, an element of the appropriate type is therefore counted in the NED header in order to represent the hardware requirements needed to invoke execution of the graph. For example, for a section that defines a convolution operation, a corresponding configuration and invocation of a convolution engine execution unit would be required. Similar counts of instantiations of weight fetch and input read execution units are counted based on the presence of sections that use those operations. This is reflected in the count in the NED header against the weight fetch and input reader elements associated with the weight fetch and input reader units in the neural engine 700.

The NED also contains information that describes any divergent or convergent branches between sections and pipes. For example the NED identifies, for each pipe in the graph, the number of producers and consumers associated with that pipe.

The NED header therefore essentially identifies the operation space and a count of all instances of sections and pipes (for each type of hardware element that is to be allocated for instantiating a section or a pipe that will be required to execute the graph (or sub-graph)) defined by the NED. An illustrative example of at least a portion of the fields stored in the NED header is set out below. In addition to the NED header, the NED further comprises sub-descriptor elements (defining either the configuration of an execution unit or storage element to operate as a section or pipe) for each instance of a section and/or pipe. Each sub-descriptor element defines the configuration of the associated hardware element (either execution unit or storage element) required to execute the section and/or pipe.

An example of at least some of the fields in a NED header is set out below:

| Field | Min | Max |
|---|---|---|
| Operation space size for dimension 1 | — | — |
| Operation space size for dimension 2 | — | — |
| Operation space size for dimension 3 | — | — |
| Operation space size for dimension 4 | — | — |
| Operation space size for dimension 5 | — | — |
| Operation space size for dimension 6 | — | — |
| Operation space size for dimension 7 | — | — |
| Number of weight fetch and decode sections | 0 | 1 |
| Number of input reader sections | 1 | 7 |
| Number of output write sections | 1 | 7 |
| Number of convolution engine sections | 0 | 1 |
| Number of transform unit sections | 0 | 7 |
| Number of vector engine sections | 0 | 7 |
| Number of pipes | 1 | 15 |

The theoretical minimum and maximum operation space dimension sizes may be defined at compilation based on the configuration of the neural engine, specifically such that the operations of the task (e.g. sub-graph) can be performed without requiring intermediate data to be stored in a memory element outside of the neural engine. A practical approach to defining a task and its corresponding operation space is set out in more detail later.

The NED header may also comprise pointers to each of the sub-descriptor elements to enable the specific configuration of each element to be read by the handling unit 720.

As mentioned, each instance of the sub-descriptor element defines a configuration of the hardware element (e.g. execution unit or storage element) to which it relates. The following description will provide an example sub-descriptor for a convolution engine.

In an example, the convolution engine is an execution unit which is configured, when invoked, to perform a convolution or pooling operation selected from one or more convolution operations for which the convolution engine is configured. One such example is a 2D convolution operation as described above. In the example of the 2D convolution operation described above, the operation space is 7D-namely [oc, n, oy, ox, ic, ky, kx].

Field
Stride X and Stride Y
Dilation X and Dilation Y
Operation type (e.g. which type of convolution
operation is to be performed)
Input width and height
Pad Left
Pad Top
Source 0 pipe (input feature map pipe)
Source 1 pipe (weight pipe)
Destination pipe

In this example, the operation type may for example take the form of one of pooling (average or max pooling), 2D convolution, or 2D depth-wise convolution. The source 0 pipe field might identify from which pipe the convolution engine should read the input feature map data—this may for example be a specific portion of a shared buffer. Similarly the source 1 pipe field might indicate from which (different) portion of the shared buffer the weight data is to be retrieved. Finally, the destination pipe might indicate that an accumulation buffer is to act as the pipe for the output of the operation performed by the convolution engine. By identifying for a section specific source and/or destination pipes, which have unique identifiers in the task definition (the NED), any preceding or subsequent sections are implicitly connected and sequenced. Another sub-descriptor element referencing the destination pipe of a different section as a source pipe will inherently read that data and the buffer allocation for that destination pipe may only be released once all of the dependencies have been resolved (e.g. that the sections that rely on that portion of the accumulation buffer have all completed reading that data).

Similar sub-descriptor elements exist for all sections based on configuring the execution units to perform operations. For example, sub-descriptor elements may define destination and source pipes, a pointer to a transform from operation to section space, and a mode of operation for the section.

In this example implementation, pipes represent all storage within the neural engine: all allocation and memory management is handled through a task's NED Pipe definitions and the traversal through the sections that produce and consume these pipes. There is no sharing of pipes between tasks and therefore no architected sharing of data between tasks within the neural engine. A sub-descriptor element is defined in the NED for each pipe in the graph. An example of a pipe sub-descriptor is set out below:

| Field | Min | Max |
|---|---|---|
| Pipe location (e.g. accumulator buffer, | 0 | 2 |
| shared buffer, LUT memory) | | |
| Number of buffers occupied by the pipe | 1 | 16 |
| Starting bank in memory | 1 | 8 |
| Number of banks used by the pipe | 1 | 8 |
| Starting word | 0 | 255 |
| Number of words per buffer | 1 | 256 |

As will be described in more detail later, these descriptors are used to configure the hardware elements when invocation is triggered by the handling unit 720.

### Neural Engine Dimensions and Iteration

In an example, a neural engine task describes a 4D bounding box (dimensions #0-3) that should be operated on by the section operations of a graph defined by a NED that the task provides a pointer to. As well as describing the graph, the NED also defines a further four dimensions (dimensions #4-7), making for a total 8-dimension operation-space. The bounding box for the first four dimensions is a sub-region of the full size of these dimensions, with different tasks and/or jobs covering other sub-regions of these dimensions. The command processing unit 640 may issue different tasks to different neural engines. As such, the dimensions 0-3 when the NED is generated or at the point that the task is defined. The latter four dimensions are described in their entirety in the NED and are therefore covered entirely in each task. The NED additionally defines an increment size for each of these 8 dimensions to be stepped through, known as a block size. Execution of the graph against this 8D operation-space can be considered as a series of nested loops.

Execution of the task's operation-space can thus be split into a series of blocks, with sections being invoked on a block-by-block basis, operating on a block's worth of data in every source and destination pipe. Consequently, defining a general operation space in a coordinate system having for example eight dimensions may provide a low complexity pattern for execution of any task comprising operations on data, instead of relying on fixed functions per task type, which may encompass a significant risk of missing necessary combinations of patterns. By defining a common operation space in a coordinate space, it may be less complex to chain a plurality of operations to be executed on data to each other and coordinate execution of these functions. Operation space dimensions do not have a specific interpretation until they are projected into space for a specific task.

The mapping of operation blocks in the operation space to local blocks in a local space dimension of an operation-specific local space enables local space dimension ranges of the local blocks in the local space dimension to be obtained. These local space dimension ranges for example correspond to coordinate ranges within the local space dimension of the operation-specific local space, to allow the local blocks to be identified and obtained for use in executing a particular operation.

The number of dimensions in use is dependent on the graph and its operations; not every section will run for increments in each dimension. For example, a convolution operation has a 7D operation-space but only a 4D output space through which the convolution operation increments and accumulates output; a VE scaling operation following a convolution thus only runs for increments in the first four dimensions.

The execution of a neural engine task may be defined by two separate iterative processes implemented in the handling unit. In one process, the handling unit iteratively steps through the task's operation-space in block units as defined by the block size of the NED. In the other process, the handling unit iteratively steps through the dataflow graph defined by the NED and, where permitted by the dimension rules described above, transforms each block into the relevant section space before invoking the section's execution unit with the transformed block by issuing invocation data.

In general, for most cases, these two processes are defined in the examples described herein to be architecturally independent. This means that the execution of any given block is defined definitively and completely in itself, in isolation of any other block or the state of the handling unit operation space iteration. The execution of blocks that are not in accordance with this operation space iteration and transformation will run to completion, but the results will not provide meaningful results with respect to full operation definitions of the Tensor Operator Set Architecture (TOSA).

In all cases, execution of a block must not extend beyond the block's section-space boundaries. Loading and storing of data (whether mapping the section-space to coordinates of a tensor in memory, to pipes, or any other memory or pipe storage) may extend beyond the section-space as required by an implementation's granularity of access, but must not extend beyond the size of a pipe's buffer. When the section space is smaller than the pipe buffer, certain reduction operations may have an additional requirement to not modify the data in the buffer beyond the section space but other operations or execution units need not have this requirement.

Iterating over the operation space may generate a block with one or more execution dimensions that are zero and/or a block with a low bound that is higher than a high bound, meaning that no functional operation is required. This may occur due to padding before the start of operation space or clipping at the end of operation space, for example. Such a block may nevertheless still be dispatched to the execution unit for correct tracking of dependencies and execution ordering.

### Programmability of Operation Space to Section Space Transforms

As discussed above, the operation space for a task (sub-graph) may contain a pre-determined number of dimensions (e.g. eight), but the local section space for the operation to be performed for a specific section in that graph can contain fewer than 8 dimensions. The handling unit may iterate through the operation space in units known as blocks, transforming each block from the common operation space to a section-specific space (which may be referred to herein as the section space or the operation-specific local space) described by the various fields in the NED. For example, the handling unit may read a block size from the NED and iterate through the operation space one block at a time. For each block, a transform program is executed to transform the operation space coordinates to section space coordinates for that section. Once the section space coordinates have been determined, the section operation is performed in respect of that block. This process is iterated over all blocks until the operation is completed for all blocks.

In an example implementation, the NED may further comprise for each element in the NED (e.g. each section/pipe) a program comprising transform program data that describes a transform from operation space to section space (local space) for the corresponding section. In one such implementation, each element in the NED may comprise an offset value that points to the specific program within the NED for executing the transform. This offset value may be regarded as a pointer into ‘program space’, being the space in which all the programs which define the various enabled transforms are located. Alternatively, the offset value may be a pointer into a virtual address space in main memory. For example, this program space can be defined in the NED as a field tsu_space_size which for example is sized as 256 bytes. The offset may point to a memory location at which the start of its section-space transform is placed (e.g. the first instruction in a sequence of instructions which collectively define a program for performing the transform).

Each transform program may end with an explicit END instruction, and may be followed without any spacing or alignment by a next program defining a sequence of instructions for executing a different transform that is associated with a different element. Alternatively a starting pointer may be used in conjunction with a total number of instructions to execute.

In an example implementation, the sequence of instructions used for each transform may be selected from a set of pre-determined instructions which effectively form an instruction set. This instruction may be regarded as a transform instruction set which may be a specific set of instructions selected optimally to perform transforms from operation space to section space. Alternatively, the transforms may be general purpose instruction set as seen in a central processing unit (CPU).

In an example implementation, a transform instruction may operate on a set of state values for the transform. The state values comprise boundary registers (in one example eight boundary registers b[0] to b[7]) each comprising a low and a high component, which may be referred to as a low and a high bound, respectively, as explained with reference to FIG. 2. Each block in the operation space is defined by the values described in the low and high components of the eight boundary registers. These values indicate the upper and lower bounds (inclusive) for the coordinates in the block for that axis of the “bounding box” operation space. As explained above, though, these boundary registers may also be used to store value data to be used in executing the operation.

In this example, no other state is available to the instructions which operate to transform the operation space to a local section space for a specific operation to be performed. All operations performed by the instructions therefore operate on the boundary registers, including intermediate calculations.

Some sequences of instructions will transform one dimension at a time, starting with dimension 0 (e.g. b[0]) and work iteratively inwards through the dimensions. In other more complex sequences of instructions, more complex transforms may need to jump around by modifying the destination register identifier explicitly e.g. by using a SETD instruction in the set of instructions.

The result of executing the transform program for a specific block defines a block in section space, ready to be used for the invocation of the specific hardware execution unit that is to execute the section. In the case of many types of operation to be performed by a hardware execution unit to execute a section, the execution unit does not use a full 8-dimension section space. The handling unit therefore defines an invocation structure for each unit that defines the relevant requirements for that operation.

### Simulator Implementation

FIG. 9 illustrates a simulator implementation 900 that may be used. Whilst the earlier described embodiments implement the present invention in terms of apparatus and methods for operating specific processing hardware supporting the techniques concerned, it is also possible to provide an instruction execution environment in accordance with the embodiments described herein which is implemented through the use of a computer program. Such computer programs are often referred to as simulators, insofar as they provide a software based implementation of a hardware architecture. Varieties of simulator computer programs include emulators, virtual machines, models, and binary translators, including dynamic binary translators. Typically, a simulator implementation may run on a host processor 940, optionally running a host operating system 930, supporting the simulator program 920. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware or provide an instruction execution environment typically associated with a different hardware architecture. An overview of simulation is given in “Some Efficient Architecture Simulation Techniques,” Robert Bedichek, Winter 1990 USENIX Conference, Pages 53-63.

To the extent that embodiments have previously been described with reference to particular hardware constructs or features, in a simulated embodiment, equivalent functionality may be provided by suitable software constructs or features. For example, particular circuitry may be implemented in a simulated embodiment as computer program logic. Similarly, memory hardware, such as a register or cache, may be implemented in a simulated embodiment as a software data structure. In arrangements where one or more of the hardware elements referenced in the previously described embodiments are present on the host hardware (for example, host processor 940), some simulated embodiments may make use of the host hardware, where suitable.

The simulator program 920 may be stored on a computer-readable storage medium (which may be a non-transitory medium), and provides a program interface (instruction execution environment) to the target code 910 which is the same as the application program interface of the hardware architecture being modelled by the simulator program 920. Thus, the pro. m instructions of the target code 910, including the control of memory accesses based on the realm protection functionality described above, may be executed from within the instruction execution environment using the simulator program 920, so that a host computer 940 which does not actually have the hardware features of the apparatus shown in FIG. 2, discussed above but can emulate these features.

The simulator program 920 is for example a computer program for controlling a host data processing apparatus to provide an instruction execution environment for execution of the target code 910 (which may be referred to as target program code). The simulator program 920 for example comprises data structure program logic for interacting with a data structure and processing program logic configured to implement methods according to examples herein, such as those described with reference to FIGS. 1 to 5.

### Programs and Systems for Implementing Examples Herein

Concepts described herein may be embodied in a system comprising at least one packaged chip. In some cases, the processor described earlier may be implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

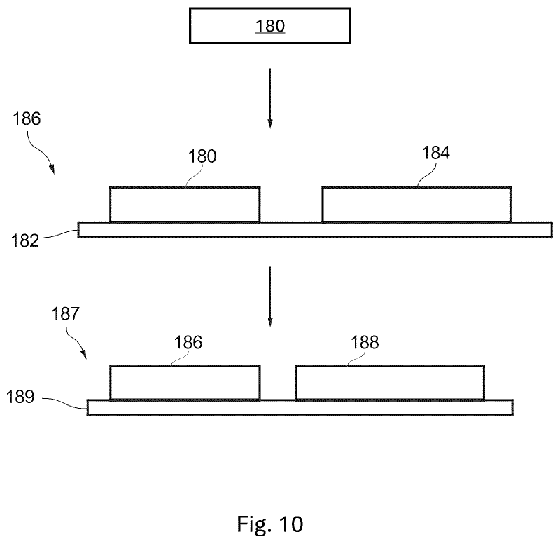

As shown in FIG. 10, one or more packaged chips 180, with the processor described above implemented on one chip or distributed over two or more of the chips, are manufactured by a semiconductor chip manufacturer. In some examples, the chip product 180 made by the semiconductor chip manufacturer may be provided as a semiconductor package which comprises a protective casing (e.g. made of metal, plastic, glass or ceramic) containing the semiconductor devices implementing the processor described above and/or connectors, such as lands, balls or pins, for connecting the semiconductor devices to an external environment. Where more than one chip 180 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 180 are assembled on a board 182 together with at least one system component 184 to provide a system 186. For example, the board may comprise a printed circuit board. The board substrate may be made of any of a variety of materials, e.g. plastic, glass, ceramic, or a flexible substrate material such as paper, plastic or textile material. The at least one system component 184 comprise one or more external components which are not part of the one or more packaged chip(s) 180. For example, the at least one system component 184 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 187 is manufactured comprising the system 186 (including the board 182, the one or more chips 180 and the at least one system component 184) and one or more product components 188. The product components 188 comprise one or more further components which are not part of the system 187. As a non-exhaustive list of examples, the one or more product components 188 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 187 and one or more product components 188 may be assembled on to a further board 189.

The board 182 or the further board 189 may be provided on or within a device housing or other structural support (e.g. a frame or blade) to provide a product which can be handled by a user and/or is intended for operational use by a person or company.

The system 186 or the chip-containing product 187 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

### Further Examples

At least some aspects of the examples described herein comprise computer processes performed in processing systems or processors. However, in some examples, the disclosure also extends to computer programs, particularly computer programs on or in an apparatus, adapted for putting the disclosure into practice. The program may be in the form of non-transitory source code, object code, a code intermediate source and object code such as in partially compiled form, or in any other non-transitory form suitable for use in the implementation of processes according to the disclosure. The apparatus may be any entity or device capable of carrying the program. For example, the apparatus may comprise a storage medium, such as a solid-state drive (SSD) or other semiconductor-based RAM; a ROM, for example, a CD ROM or a semiconductor ROM; a magnetic recording medium, for example, a floppy disk or hard disk; optical memory devices in general; etc.

The term processing element, processor, or processing unit (terms may be used interchangeably) has been used above to describe a hardware component that performs processing on data. The term encompasses, without limitation, central processing units (CPU), graphical processing units (GPU) and Neural Processing units/Tensor Processing units (NPU/TPU). Where the term CPU, GPU, NPU/TPU has been used this term may be generalized to the term processor.

In some implementations, the processor may comprise a chip. The chip (sometimes referred to as system on a chip SoC) may comprise multiple components, such as CPU, GPU, NPU and a storage component. In some implementations, the component may include circuits embedded on a single piece of material, such as a semiconductor wafer. As explained below, which circuits form part of each of the CPU, GPU, and NPU may be a matter of definition rather than inherent properties of the circuits.

The storage may be a unified storage that may be accessible by one, more, or all of the circuits on the chip. Allowing each circuit to access the same storage may improve the speed with which data can be processed.

Terms such as CPU, GPU and NPU are referred to in the art, but their meaning may depend on context. The CPU may be a ‘central’ or ‘main’ processing unit. However, in distributed systems or systems where there are multiple processing cores, the concept of a ‘main’ or ‘central’ processing unit may not be relevant. Further, while a GPU may be a hardware accelerator for graphics processing tasks, a GPU may sometimes be used for accelerating processing of neural networks. Further, there may be aspects of a graphics task that involve processing of neural networks. Accordingly, a GPU may be considered to be an NPU and vice versa depending on the context of the processing and/or intended primary purpose of the processor.

A typical feature of NPU and GPU designs is an ability to perform certain operations in parallel resulting in hardware acceleration. Correspondingly, a trend in CPU design has been the inclusion of an increased numbers of cores that increase the ability to process data in parallel. Accordingly, it is to be appreciated that parallel processing may be performed using various processor types.

One or more embodiments above may have been described in the context of one or more of a CPU, GPU, or NPU. For the avoidance of doubt, the techniques described herein may be applied more generally to a processor for the reasons given above.

In the preceding description, for purposes of explanation, numerous specific details of certain examples are set forth. Reference in the specification to “an example” or similar language means that a particular feature, structure, or characteristic described in connection with the example is included in at least that one example, but not necessarily in other examples.

It is to be understood that any feature described in relation to any one example may be used alone, or in combination with other features described, and may also be used in combination with one or more features of any other of the example, or any combination of any other of the examples. Furthermore, equivalents and modifications not described above may also be employed without departing from the scope of the disclosure, which is defined in the accompanying claims.

Further examples are set out in the following numbered clauses:

1. An apparatus comprising storage, an execution unit and a handling unit, wherein the handling unit is configured to:
obtain task data that describes a task to be executed, the task comprising a plurality of operations representable as a directed graph of operations comprising operations connected by connections corresponding to respective logical storage locations,
wherein the task data comprises value selection data for use in selecting value data representing a value for use in executing an operation of the operations, the operation comprising processing input data from an input logical storage location of the logical storage locations with the value data;
use the value selection data to select the value data; and
dispatch invocation data, based on the task data and the value data, to the execution unit to cause the execution unit to execute the operation.

2. The apparatus of clause 1, wherein the value selection data indicates whether the handling unit is to select a field of the task data, corresponding to the value data, as the value data.

3. The apparatus of clause 1 or clause 2, wherein the value selection data indicates whether the handling unit is to select derived value data as the value data, wherein the derived value data is derived from at least a portion of the task data by processing at least the portion of the task data, using the handling unit.

4. The apparatus of clause 3, wherein the value selection data indicates that the handling unit is to select the derived value data as the value data, the task data defines a multi-dimensional nested loop defining an operation space, and the handling unit is configured to:
iterate over the operation space in blocks; and
derive the derived value data on a per-block basis for a plurality of the blocks.

5. The apparatus of clause 4, wherein the handling unit is configured to derive the derived value data for a particular block based on a position associated with the particular block, within the operation space.

6. The apparatus of clause 5, wherein the position is indicative of at least one of:
an element position of a predefined element of the particular block within the operation space; or
a relative element position of the predefined element of the particular block relative to a predefined reference element of a reference block within the operation space.

7. The apparatus of clause 5 or clause 6, wherein the position is representable using at least one coordinate, each of the at least one coordinate indicative of the position in a different respective dimension of the operation space, and the derived value data is based on a linear function of the at least one coordinate.

8. The apparatus of clause 7, wherein the handling unit is configured to derive further derived value data for a further block of the blocks based on the linear function, the further derived value data representing a further derived value.

9. The apparatus of any one of clauses 4 to 8, wherein the handling unit is configured to derive the derived value data as part of a procedure to map each block of the plurality of the blocks in the operation space to a different respective local block in a local space.

10. The apparatus of any one of clauses 4 to 9, wherein the storage comprises, for each dimension of the multi-dimensional nested loop, a respective boundary register for storing, for a given block of the blocks, range data defining a range of the given block in the respective dimension, and the handling unit is configured to write the derived value data to a boundary register of the boundary registers.

11. The apparatus of clause 4, wherein, for a particular block of the blocks, the derived value data is independent of a position associated with the particular block, within the operation space.

12. The apparatus of any one of clauses 1 to 11, wherein the operation comprises processing input blocks of data and, for a particular input block of the input blocks, the operation comprises processing each of a plurality of elements of the particular input block, respectively, with the value represented by the value data.

13. The apparatus of clause 12, wherein the operation comprises:
generating a first output block, based on the processing of each of the plurality of elements of the particular input block, respectively, with the value, the first output block comprising first element values in accordance with a first pattern;
generating a second output block, based on the processing of each of the plurality of elements of at least one of: the particular input block or a further input block, respectively, with the value, the second output block comprising second element values in accordance with a second pattern; and
performing an elementwise comparison of the first output block and the second output block to generate a mask output block.

14. The apparatus of clause 13, wherein the generating the first output block comprises:
adding the value to each of the elements in a first dimension of the particular input block to generate a first set of element values having a first precursor pattern in the first dimension; and
broadcasting the first precursor pattern to each of at least one further dimension of the first output block to generate the first output block comprising the first element values having the first pattern, the at least one further dimension comprising a second dimension, and the generating the second output block comprises:
adding the value to each of the elements in a second dimension of the at least one of: the particular input block or the further input block to generate a second set of element values having a second precursor pattern in a second dimension corresponding to the second dimension of the first output block; and
broadcasting the second precursor pattern to each of at least one further dimension of the second output block to generate the second output block comprising the second element values having the second pattern, the at least one further dimension comprising a first dimension corresponding to the first dimension of the first output block.

15. The apparatus of any one of clauses 1 to 14, wherein the invocation data comprises at least one of: the value data or the value selection data.

16. The apparatus of any one of clauses 1 to 15, wherein the task data comprises further value selection data for use in selecting further value data representing a further value for executing a further operation of the operations, the further operation comprising processing further input data from a further input logical storage location of the logical storage locations with the further value data, the handling unit is configured to use the further value selection data to select the further value data, and the invocation data is further based on the further value data to cause the execution unit to execute the further operation.

17. A system comprising:
the apparatus of any one of clauses 1 to 16, implemented in at least one packaged chip;
at least one system component; and
a board,
wherein the at least one packaged chip and the at least one system component are assembled on the board.

18. A chip-containing product comprising the system of clause 17, wherein the system is assembled on a further board with at least one other product component.

19. A non-transitory computer-readable medium having stored thereon computer-readable code for fabrication of the apparatus of any one of clauses 1 to 16.

20. A method comprising:
obtaining, by handling circuitry, task data that describes a task to be executed, the task comprising a plurality of operations representable as a directed graph of operations comprising operations connected by connections corresponding to respective logical storage locations,
wherein the task data comprises value selection data for use in selecting value data representing a value for use in executing an operation of the operations, the operation comprising processing input data from an input logical storage location of the logical storage locations with the value data;
using, by the handling circuitry, the value selection data to select the value data; and
dispatching, by the handling circuitry, invocation data, based on the task data and the value data, to execution circuitry for execution of the operation.

What is claimed is:

1. An apparatus comprising storage, an execution unit and a handling unit, wherein the handling unit is configured to:
obtain task data that describes a task to be executed, the task comprising a plurality of operations representable as a directed graph of operations comprising operations connected by connections corresponding to respective logical storage locations,
wherein the task data comprises value selection data for use in selecting value data representing a value for use in executing an operation of the operations, the operation comprising processing input data from an input logical storage location of the logical storage locations with the value data;
use the value selection data to select the value data; and
dispatch invocation data, based on the task data and the value data, to the execution unit to cause the execution unit to execute the operation.

2. The apparatus of claim 1, wherein the value selection data indicates whether the handling unit is to select a field of the task data, corresponding to the value data, as the value data.

3. The apparatus of claim 1, wherein the value selection data indicates whether the handling unit is to select derived value data as the value data, wherein the derived value data is derived from at least a portion of the task data by processing at least the portion of the task data, using the handling unit.

4. The apparatus of claim 3, wherein the value selection data indicates that the handling unit is to select the derived value data as the value data, the task data defines a multi-dimensional nested loop defining an operation space, and the handling unit is configured to:
iterate over the operation space in blocks; and
derive the derived value data on a per-block basis for a plurality of the blocks.

5. The apparatus of claim 4, wherein the handling unit is configured to derive the derived value data for a particular block based on a position associated with the particular block, within the operation space.

6. The apparatus of claim 5, wherein the position is indicative of at least one of:
an element position of a predefined element of the particular block within the operation space; or
a relative element position of the predefined element of the particular block relative to a predefined reference element of a reference block within the operation space.

7. The apparatus of claim 5, wherein the position is representable using at least one coordinate, each of the at least one coordinate indicative of the position in a different respective dimension of the operation space, and the derived value data is based on a linear function of the at least one coordinate.

8. The apparatus of claim 7, wherein the handling unit is configured to derive further derived value data for a further block of the blocks based on the linear function, the further derived value data representing a further derived value.

9. The apparatus of claim 4, wherein the handling unit is configured to derive the derived value data as part of a procedure to map each block of the plurality of the blocks in the operation space to a different respective local block in a local space.

10. The apparatus of claim 4, wherein the storage comprises, for each dimension of the multi-dimensional nested loop, a respective boundary register for storing, for a given block of the blocks, range data defining a range of the given block in the respective dimension, and the handling unit is configured to write the derived value data to a boundary register of the boundary registers.

11. The apparatus of claim 4, wherein, for a particular block of the blocks, the derived value data is independent of a position associated with the particular block, within the operation space.

12. The apparatus of claim 1, wherein the operation comprises processing input blocks of data and, for a particular input block of the input blocks, the operation comprises processing each of a plurality of elements of the particular input block, respectively, with the value represented by the value data.

13. The apparatus of claim 12, wherein the operation comprises:
generating a first output block, based on the processing of each of the plurality of elements of the particular input block, respectively, with the value, the first output block comprising first element values in accordance with a first pattern;
generating a second output block, based on the processing of each of the plurality of elements of at least one of: the particular input block or a further input block, respectively, with the value and/or a further value, the second output block comprising second element values in accordance with a second pattern; and
performing an elementwise comparison of at least part of the first output block and a corresponding at least part of the second output block to generate a mask output block.

14. The apparatus of claim 13, wherein the generating the first output block comprises:
adding the value to each of the elements in a first dimension of the particular input block to generate a first set of element values having a first precursor pattern in the first dimension; and
broadcasting the first precursor pattern to each of at least one further dimension of the first output block to generate the first output block comprising the first element values having the first pattern, the at least one further dimension comprising a second dimension, and
the generating the second output block comprises:
adding the value and/or the further value to each of the elements in a second dimension of the at least one of: the particular input block or the further input block to generate a second set of element values having a second precursor pattern in a second dimension corresponding to the second dimension of the first output block; and
broadcasting the second precursor pattern to each of at least one further dimension of the second output block to generate the second output block comprising the second element values having the second pattern, the at least one further dimension comprising a first dimension corresponding to the first dimension of the first output block.

15. The apparatus of claim 1, wherein the invocation data comprises at least one of: the value data or the value selection data.

16. The apparatus of claim 1, wherein the task data comprises further value selection data for use in selecting further value data representing a further value for executing a further operation of the operations, the further operation comprising processing further input data from a further input logical storage location of the logical storage locations with the further value data, the handling unit is configured to use the further value selection data to select the further value data, and the invocation data is further based on the further value data to cause the execution unit to execute the further operation.

17. A system comprising:
the apparatus of claim 1, implemented in at least one packaged chip;
at least one system component; and
a board,
wherein the at least one packaged chip and the at least one system component are assembled on the board.

18. A chip-containing product comprising the system of claim 17, wherein the system is assembled on a further board with at least one other product component.

19. A non-transitory computer-readable medium having stored thereon computer-readable code for fabrication of the apparatus of claim 1.

20. A method comprising:
obtaining, by handling circuitry, task data that describes a task to be executed, the task comprising a plurality of operations representable as a directed graph of operations comprising operations connected by connections corresponding to respective logical storage locations,
wherein the task data comprises value selection data for use in selecting value data representing a value for use in executing an operation of the operations, the operation comprising processing input data from an input logical storage location of the logical storage locations with the value data;
using, by the handling circuitry, the value selection data to select the value data; and
dispatching, by the handling circuitry, invocation data, based on the task data and the value data, to execution circuitry for execution of the operation.
